(19) United States
(12) Patent Application Publication
(10) Pub. No.: US 2025/0379972 A1
(43) Pub. Date: Dec. 11, 2025

(54) ELECTRONIC DEVICE AND NON-TRANSITORY MACHINE-READABLE MEDIUM FOR DECODING OR ENCODING VIDEO DATA

(71) Applicant: SHARP KABUSHIKI KAISHA, Sakai City (JP)

(72) Inventors: Chih-Yu Teng, New Taipei City (TW); Yu-Chiao Yang, New Taipei City (TW)

(21) Appl. No.: 19/233,334

(22) Filed: Jun. 10, 2025

Related U.S. Application Data
(60) Provisional application No. 63/658,610, filed on Jun. 11, 2024.

(51) Int. Cl. H04N 19/117; H04N 19/105; H04N 19/167; H04N 19/176

(52) U.S. Cl. CPC H04N 19/117; H04N 19/105; H04N 19/167; H04N 19/176

(57) ABSTRACT

A method of decoding and/or encoding video data is provided. The method includes: receiving the video data; determining a chroma block unit from an image frame of the video data; determining a guiding block vector of the chroma block unit; determining a first chroma relocated block that is indicated by the guiding block vector, of the chroma block unit, that starts from the chroma block unit; determining a first relocated cross-component prediction (CCP) filter based on a first relocated position of the first chroma relocated block, where the first relocated CCP filter is one of a plurality of CCP relocated candidates in a CPP relocated list of the chroma block unit; and reconstructing the chroma block unit based on the CCP relocated list of the chroma block unit. Furthermore, an electronic device and a non-transitory machine-readable medium of an electronic device using the method are also provided.

### CROSS-REFERENCE TO RELATED APPLICATION(S)

The present disclosure claims the benefit of and priority to U.S. Provisional Patent Application Ser. No. 63/658,610, filed on Jun. 11, 2024, entitled “VECTOR GUIDED CROSS COMPONENT PREDICTION METHOD,” the content of which is hereby incorporated herein fully by reference in its entirety for all purposes.

### FIELD

The present disclosure generally relates to video coding, and more specifically, to techniques for predicting a chroma block unit of a block unit using a cross-component prediction filter of the block unit, which is determined based on a relocated vector of the block unit.

### BACKGROUND

Cross-component prediction (CCP) mode is a chroma coding tool for video coding, in which, an encoder and/or a decoder may predict a chroma block of a current block based on a luma block of the current block by using a prediction model.

In addition, the encoder and/or the decoder may derive the prediction model of the chroma block inherited from one of neighboring blocks generated prior to the reconstruction of the chroma block. The neighboring blocks may have neighboring models. The neighboring models of the neighboring blocks, however, may be just multiple potential models, but not the most appropriate model. Thus, the neighboring models of the neighboring blocks may be inadequate to precisely and efficiently predict all of several chroma samples in the chroma block.

Thus, model refinement modes for determining multiple candidate models of the chroma block may be required for the encoder and/or the decoder to be able to precisely and efficiently predict and/or reconstruct the chroma block of the block unit.

### SUMMARY

The present disclosure is directed to a non-transitory machine-readable medium and an electronic device for predicting a chroma block unit of a block unit by using a cross-component filter, derived based on a guiding block vector of a chroma block unit.

In a first aspect of the present disclosure, a non-transitory machine-readable medium of an electronic device storing one or more computer-executable instructions for decoding video data is provided. The one or more computer-executable instructions, when executed by at least one processor of the electronic device, cause the electronic device to: receive the video data; determine a chroma block unit from an image frame of the video data; determine a guiding block vector of the chroma block unit; determine a first chroma relocated block that is indicated by the guiding block vector, of the chroma block unit, starts from from the chroma block unit; determine a first relocated cross-component prediction (CCP) filter based on a first relocated position of the first chroma relocated block, wherein the first relocated CCP filter is one of multiple CCP relocated candidates in a CPP relocated list of the chroma block unit; and reconstruct the chroma block unit based on the CCP relocated list of the chroma block unit.

In an implementation of the first aspect of the present disclosure, the one or more computer-executable instructions, when executed by at least one processor of the electronic device, further cause the electronic device to: determine at least one chroma relocated prediction mode of at least one chroma relocated unit, wherein: each of the at least one chroma relocated unit is associated with the first chroma relocated block, and a first one of the at least one chroma relocated unit is reconstructed by using the first relocated CCP filter when the first one of the at least one chroma relocated unit is reconstructed by using a CCP prediction mode and covers the first relocated position of the first chroma relocated block.

In another implementation of the first aspect of the present disclosure, the one or more computer-executable instructions, when executed by the at least one processor, further cause the electronic device to: determine a second relocated CCP filter based on a second relocated position of the first chroma relocated block, wherein a second one of the at least one chroma relocated unit is reconstructed by using the second relocated CCP filter when the second one of the at least one chroma relocated unit is reconstructed by using the CCP prediction mode and covers the second relocated position of the first chroma relocated block; and determine the second relocated CCP filter as one of the multiple CCP relocated candidates in the CPP relocated list of the chroma block unit.

In another implementation of the first aspect of the present disclosure, the one or more computer-executable instructions, when executed by the at least one processor, further cause the electronic device to: determine a first relocated block vector based on a second relocated position of the first chroma relocated block; determine a second chroma relocated block that is indicated by the first relocated block vector that starts from the first chroma relocated block; and determine a second relocated CCP filter based on a first relocated position of the second chroma relocated block, wherein the second relocated CCP filter is one of the multiple CCP relocated candidates in the CPP relocated list of the chroma block unit.

In another implementation of the first aspect of the present disclosure, the one or more computer-executable instructions, when executed by the at least one processor, further cause the electronic device to: determine at least one chroma relocated prediction mode of at least one chroma relocated unit, wherein: each of the at least one chroma relocated unit is associated with the first chroma relocated block, and a first one of the at least one chroma relocated unit is reconstructed by using the first relocated block vector when the first one of the at least one chroma relocated unit is reconstructed by using a block vector prediction mode and covers the second relocated position of the first chroma relocated block.

In another implementation of the first aspect of the present disclosure, determining the second chroma relocated block that is indicated by the first relocated block vector that starts from the first chroma relocated block further comprises: determining a center position of the second chroma relocated block that is indicated by the first relocated block vector that starts from the second relocated position of the first chroma relocated block; and determining the second chroma relocated block based on the center position of the second chroma relocated block and a size of the chroma block unit.

In another implementation of the first aspect of the present disclosure, the one or more computer-executable instructions, when executed by the at least one processor, further cause the electronic device to: determine an (N−1)-th relocated block vector based on a relocated position of an (N−1)-th chroma relocated block; determine an N-th chroma relocated block that is indicated by the (N−1)-th relocated block vector that starts from the (N−1)-th chroma relocated block, wherein the number N is a relocated level of the N-th chroma relocated block; determine at least one chroma relocated prediction mode of at least one chroma relocated unit, wherein each of the at least one chroma relocated unit is associated with the N-th chroma relocated block; and forgo determining whether the at least one chroma relocated unit is reconstructed by using a block vector prediction mode when the relocated level of the N-th chroma relocated block equal to N is equal to a relocated level threshold.

In another implementation of the first aspect of the present disclosure, at least one of the multiple CCP relocated candidates is included in a CCP merge list of the chroma block unit.

In a second aspect of the present disclosure, an electronic device for decoding video data is provided. The electronic device includes at least one processor and one or more non-transitory computer-readable media that are coupled to the at least one processor. The one or more non-transitory computer-readable media store one or more computer-executable instructions that, when executed by the at least one processor, cause the electronic device to: receive the video data; determine a chroma block unit from an image frame of the video data; determine a guiding block vector of the chroma block unit; determine a first chroma relocated block that is indicated by the guiding block vector, of the chroma block unit, that starts from the chroma block unit; determine a first relocated cross-component prediction (CCP) filter based on a first relocated position of the first chroma relocated block, wherein the first relocated CCP filter is one of multiple CCP relocated candidates in a CPP relocated list of the chroma block unit; and reconstruct the chroma block unit based on the CCP relocated list of the chroma block unit.

In an implementation of the second aspect of the present disclosure, the one or more computer-executable instructions, when executed by the at least one processor of the electronic device, further cause the electronic device to: determine at least one chroma relocated prediction mode of at least one chroma relocated unit, wherein: each of the at least one chroma relocated unit is associated with the first chroma relocated block, and a first one of the at least one chroma relocated unit is reconstructed by using the first relocated CCP filter when the first one of the at least one chroma relocated unit is reconstructed by using a CCP prediction mode and covers the first relocated position of the first chroma relocated block.

In another implementation of the second aspect of the present disclosure, the one or more computer-executable instructions, when executed by the at least one processor, further cause the electronic device to: determine a second relocated CCP filter based on a second relocated position of the first chroma relocated block, wherein a second one of the at least one chroma relocated unit is reconstructed by using the second relocated CCP filter when the second one of the at least one chroma relocated unit is reconstructed by using the CCP prediction mode and covers the second relocated position of the first chroma relocated block; and determine the second relocated CCP filter as one of the multiple CCP relocated candidates in the CPP relocated list of the chroma block unit.

In another implementation of the second aspect of the present disclosure, the one or more computer-executable instructions, when executed by the at least one processor, further cause the electronic device to: determine a first relocated block vector based on a second relocated position of the first chroma relocated block; determine a second chroma relocated block that is indicated by the first relocated block vector that starts from the first chroma relocated block; and determine a second relocated CCP filter based on a first relocated position of the second chroma relocated block, wherein the second relocated CCP filter is one of the multiple CCP relocated candidates in the CPP relocated list of the chroma block unit.

In another implementation of the second aspect of the present disclosure, the one or more computer-executable instructions, when executed by the at least one processor, further cause the electronic device to: determine at least one chroma relocated prediction mode of at least one chroma relocated unit, wherein: each of the at least one chroma relocated unit is associated with the first chroma relocated block, and a first one of the at least one chroma relocated unit is reconstructed by using the first relocated block vector when the first one of the at least one chroma relocated unit is reconstructed by using a block vector prediction mode and covers the second relocated position of the first chroma relocated block.

In another implementation of the second aspect of the present disclosure, determining the second chroma relocated block that is indicated by the first relocated block vector that starts from the first chroma relocated block further comprises: determining a center position of the second chroma relocated block that is indicated by the first relocated block vector that starts from the second relocated position of the first chroma relocated block; and determining the second chroma relocated block based on the center position of the second chroma relocated block and a size of the chroma block unit.

In another implementation of the second aspect of the present disclosure, the one or more computer-executable instructions, when executed by the at least one processor, further cause the electronic device to: determine an (N−1)-th relocated block vector based on a relocated position of an (N−1)-th chroma relocated block; determine an N-th chroma relocated block that is indicated by the (N−1)-th relocated block vector that starts from the (N−1)-th chroma relocated block, wherein the number N is a relocated level of the N-th chroma relocated block; determine at least one chroma relocated prediction mode of at least one chroma relocated unit, wherein each of the at least one chroma relocated unit is associated with the N-th chroma relocated block; and forgo determining whether the at least one chroma relocated unit is reconstructed by using a block vector prediction mode when the relocated level of the N-th chroma relocated block equal to N is equal to a relocated level threshold.

In another implementation of the second aspect of the present disclosure, at least one of the multiple CCP relocated candidates is included in a CCP merge list of the chroma block unit.

In a third aspect of the present disclosure, an electronic device for encoding video data is provided. The electronic device includes at least one processor and one or more non-transitory computer-readable media that are coupled to the at least one processor. The one or more non-transitory computer-readable media store one or more computer-executable instructions that, when executed by the at least one processor, cause the electronic device to: receive the video data; determine a chroma block unit from an image frame of the video data; determine a guiding block vector of the chroma block unit; determine a first chroma relocated block that is indicated by the guiding block vector, of the chroma block unit, that starts from the chroma block unit; determine a first relocated cross-component prediction (CCP) filter based on a first relocated position of the first chroma relocated block, wherein the first relocated CCP filter is one of multiple CCP relocated candidates in a CPP relocated list of the chroma block unit; and reconstruct the chroma block unit based on the CCP relocated list of the chroma block unit.

In an implementation of the third aspect of the present disclosure, the one or more computer-executable instructions, when executed by the at least one processor of the electronic device, further cause the electronic device to: determine at least one chroma relocated prediction mode of at least one chroma relocated unit, wherein: each of the at least one chroma relocated unit is associated with the first chroma relocated block, and a first one of the at least one chroma relocated unit is reconstructed by using the first relocated CCP filter when the first one of the at least one chroma relocated unit is reconstructed by using a CCP prediction mode and covers the first relocated position of the first chroma relocated block.

In another implementation of the third aspect of the present disclosure, the one or more computer-executable instructions, when executed by the at least one processor, further cause the electronic device to: determine a second relocated CCP filter based on a second relocated position of the first chroma relocated block, wherein a second one of the at least one chroma relocated unit is reconstructed by using the second relocated CCP filter when the second one of the at least one chroma relocated unit is reconstructed by using the CCP prediction mode and covers the second relocated position of the first chroma relocated block; and determine the second relocated CCP filter as one of the multiple CCP relocated candidates in the CPP relocated list of the chroma block unit.

In another implementation of the third aspect of the present disclosure, the one or more computer-executable instructions, when executed by the at least one processor, further cause the electronic device to: determine a first relocated block vector based on a second relocated position of the first chroma relocated block; determine a second chroma relocated block that is indicated by the first relocated block vector that starts from the first chroma relocated block; and determine a second relocated CCP filter based on a first relocated position of the second chroma relocated block, wherein the second relocated CCP filter is one of the multiple CCP relocated candidates in the CPP relocated list of the chroma block unit.

In another implementation of the third aspect of the present disclosure, the one or more computer-executable instructions, when executed by the at least one processor, further cause the electronic device to: determine at least one chroma relocated prediction mode of at least one chroma relocated unit, wherein: each of the at least one chroma relocated unit is associated with the first chroma relocated block, and a first one of the at least one chroma relocated unit is reconstructed by using the first relocated block vector when the first one of the at least one chroma relocated unit is reconstructed by using a block vector prediction mode and covers the second relocated position of the first chroma relocated block.

In another implementation of the third aspect of the present disclosure, determining the second chroma relocated block that is indicated by the first relocated block vector that starts from the first chroma relocated block further comprises: determining a center position of the second chroma relocated block that is indicated by the first relocated block vector that starts from the second relocated position of the first chroma relocated block; and determining the second chroma relocated block based on the center position of the second chroma relocated block and a size of the chroma block unit.

In another implementation of the third aspect of the present disclosure, the one or more computer-executable instructions, when executed by the at least one processor, further cause the electronic device to: determine an (N−1)-th relocated block vector based on a relocated position of an (N−1)-th chroma relocated block; determine an N-th chroma relocated block that is indicated by the (N−1)-th relocated block vector that starts from the (N−1)-th chroma relocated block, wherein the number N is a relocated level of the (N−1)-th chroma relocated block; determine at least one chroma relocated prediction mode of at least one chroma relocated unit, wherein each of the at least one chroma relocated unit is associated with the N-th chroma relocated block; and forgo determining whether the at least one chroma relocated unit is reconstructed by using a block vector prediction mode when the relocated level of the N-th chroma relocated block equal to N is equal to a relocated level threshold.

In another implementation of the third aspect of the present disclosure, at least one of the multiple CCP relocated candidates is included in a CCP merge list of the chroma block unit.

### BRIEF DESCRIPTION OF THE DRAWINGS

Aspects of the present disclosure are best understood from the following detailed disclosure and the corresponding figures. Various features are not drawn to scale and dimensions of various features may be arbitrarily increased or reduced for clarity of discussion.

FIG. 1 is a block diagram illustrating a system having a first electronic device and a second electronic device for encoding and decoding video data, in accordance with one or more example implementations of this disclosure.

FIG. 2 is a block diagram illustrating a decoder module of the second electronic device illustrated in FIG. 1, in accordance with one or more example implementations of this disclosure.

FIG. 3 is a flowchart illustrating a method/process for decoding and/or encoding video data by an electronic device, in accordance with one or more example implementations of this disclosure.

FIGS. 4A-4C are schematic diagrams illustrating different chroma relocated blocks that are indicated by the same guiding block vector that starts from the same guiding start position to different guiding end positions, in accordance with one or more example implementations of this disclosure.

FIG. 5 is a schematic diagram illustrating a second chroma relocated block that is indicated by a first relocated block vector, in accordance with one or more example implementations of this disclosure.

FIG. 6 is a schematic diagram illustrating multiple chroma relocated blocks that are indicated by multiple relocated block vectors and that are in different relocated levels, in accordance with one or more example implementations of this disclosure.

FIG. 7 is a block diagram illustrating an encoder module of the first electronic device illustrated in FIG. 1, in accordance with one or more example implementations of this disclosure.

### DETAILED DESCRIPTION

The following disclosure contains specific information pertaining to implementations in the present disclosure. The figures and the corresponding detailed disclosure are directed to example implementations. However, the present disclosure is not limited to these example implementations. Other variations and implementations of the present disclosure will occur to those skilled in the art.

Unless noted otherwise, like or corresponding elements among the figures may be indicated by like or corresponding reference designators. The figures and illustrations in the present disclosure are generally not to scale and are not intended to correspond to actual relative dimensions.

For the purposes of consistency and ease of understanding, features are identified (although, in some examples, not illustrated) by reference designators in the exemplary figures. However, the features in different implementations may differ in other respects and shall not be narrowly confined to what is illustrated in the figures.

The disclosure uses the phrases “in one implementation,” or “in some implementations,” which may refer to one or more of the same or different implementations. The term “coupled” is defined as connected, whether directly or indirectly through intervening components, and is not necessarily limited to physical connections. The term “comprising” means “including, but not necessarily limited to” and specifically indicates open-ended inclusion or membership in the so-described combination, group, series, and the equivalent.

For purposes of explanation and non-limitation, specific details, such as functional entities, techniques, protocols, and standards, are set forth for providing an understanding of the disclosed technology. Detailed disclosure of well-known methods, technologies, systems, and architectures are omitted so as not to obscure the present disclosure with unnecessary details.

Persons skilled in the art will recognize that any disclosed coding function(s) or algorithm(s) described in the present disclosure may be implemented by hardware, software, or a combination of software and hardware. Disclosed functions may correspond to modules that are software, hardware, firmware, or any combination thereof.

A software implementation may include a program having one or more computer-executable instructions stored on a computer-readable medium, such as memory or other types of storage devices. For example, one or more microprocessors or general-purpose computers with communication processing capability may be programmed with computer-executable instructions and perform the disclosed function(s) or algorithm(s).

The microprocessors or general-purpose computers may be formed of application-specific integrated circuits (ASICs), programmable logic arrays, and/or one or more digital signal processors (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes, but is not limited to, random-access memory (RAM), read-only memory (ROM), erasable programmable read-only memory (EPROM), electrically erasable programmable read-only memory (EEPROM), flash memory, compact disc read-only memory (CD ROM), magnetic cassettes, magnetic tape, magnetic disk storage, or any other equivalent medium capable of storing computer-executable instructions. The computer-readable medium may be a non-transitory computer-readable medium.

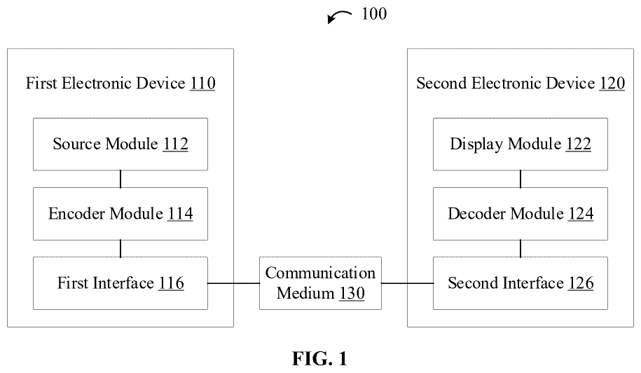

FIG. 1 is a block diagram illustrating a system 100 having a first electronic device and a second electronic device for encoding and decoding video data, in accordance with one or more example implementations of this disclosure.

The system 100 may include a first electronic device 110, a second electronic device 120, and a communication medium 130.

The first electronic device 110 may be a source device including any device configured to encode video data and transmit the encoded video data to the communication medium 130. The second electronic device 120 may be a destination device including any device configured to receive encoded video data via the communication medium 130 and decode the encoded video data.

The first electronic device 110 may communicate via wire, or wirelessly, with the second electronic device 120 via the communication medium 130. The first electronic device 110 may include a source module 112, an encoder module 114, and a first interface 116, among other components. The second electronic device 120 may include a display module 122, a decoder module 124, and a second interface 126, among other components. The first electronic device 110 may be a video encoder and the second electronic device 120 may be a video decoder.

The first electronic device 110 and/or the second electronic device 120 may be a mobile phone, a tablet, a desktop, a notebook, or other electronic devices. FIG. 1 illustrates one example of the first electronic device 110 and the second electronic device 120. The first electronic device 110 and second electronic device 120 may include greater or fewer components than illustrated or have a different configuration of the various illustrated components.

The source module 112 may include a video capture device to capture new video, a video archive to store previously captured video, and/or a video feed interface to receive the video from a video content provider. The source module 112 may generate computer graphics-based data, as the source video, or may generate a combination of live video, archived video, and computer-generated video, as the source video. The video capture device may include a charge-coupled device (CCD) image sensor, a complementary metal-oxide-semiconductor (CMOS) image sensor, or a camera.

The encoder module 114 and the decoder module 124 may each be implemented as any one of a variety of suitable encoder/decoder circuitry, such as one or more microprocessors, a central processing unit (CPU), a graphics processing unit (GPU), a system-on-a-chip (SoC), digital signal processors (DSPs), application-specific integrated circuits (ASICs), field-programmable gate arrays (FPGAs), discrete logic, software, hardware, firmware, or any combinations thereof. When implemented partially in software, a device may store the program having computer-executable instructions for the software in a suitable, non-transitory computer-readable medium and execute the stored computer-executable instructions using one or more processors to perform the disclosed methods. Each of the encoder module 114 and the decoder module 124 may be included in one or more encoders or decoders, any of which may be integrated as part of a combined encoder/decoder (CODEC) in a device.

The first interface 116 and the second interface 126 may utilize customized protocols or follow existing standards or de facto standards including, but not limited to, Ethernet, IEEE 802.11 or IEEE 802.15 series, wireless USB, or telecommunication standards including, but not limited to, Global System for Mobile Communications (GSM), Code-Division Multiple Access 2000 (CDMA2000), Time Division Synchronous Code Division Multiple Access (TD-SCDMA), Worldwide Interoperability for Microwave Access (WiMAX), Third Generation Partnership Project Long-Term Evolution (3GPP-LTE), or Time-Division LTE (TD-LTE). The first interface 116 and the second interface 126 may each include any device configured to transmit a compliant video bitstream via the communication medium 130 and to receive the compliant video bitstream via the communication medium 130.

The first interface 116 and the second interface 126 may include a computer system interface that enables a compliant video bitstream to be stored on a storage device or to be received from the storage device. For example, the first interface 116 and the second interface 126 may include a chipset supporting Peripheral Component Interconnect (PCI) and Peripheral Component Interconnect Express (PCIe) bus protocols, proprietary bus protocols, Universal Serial Bus (USB) protocols, Inter-Integrated Circuit (I2C) protocols, or any other logical and physical structure(s) that may be used to interconnect peer devices.

The display module 122 may include a display using liquid crystal display (LCD) technology, plasma display technology, organic light-emitting diode (OLED) display technology, or light-emitting polymer display (LPD) technology, with other display technologies used in some other implementations. The display module 122 may include a High-Definition display or an Ultra-High-Definition display.

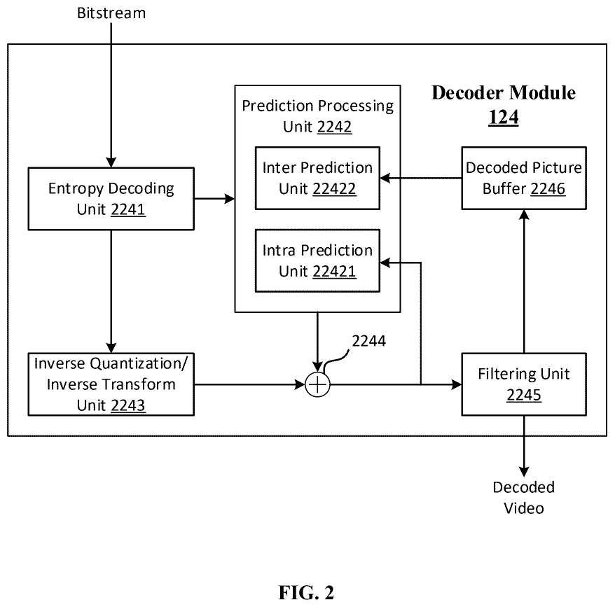

FIG. 2 is a block diagram illustrating a decoder module 124 of the second electronic device 120 illustrated in FIG. 1, in accordance with one or more example implementations of this disclosure. The decoder module 124 may include an entropy decoder (e.g., an entropy decoding unit 2241), a prediction processor (e.g., a prediction processing unit 2242), an inverse quantization/inverse transform processor (e.g., an inverse quantization/inverse transform unit 2243), a summer (e.g., a summer 2244), a filter (e.g., a filtering unit 2245), and a decoded picture buffer (e.g., a decoded picture buffer 2246). The prediction processing unit 2242 further may include an intra prediction processor (e.g., an intra prediction unit 22421) and an inter prediction processor (e.g., an inter prediction unit 22422). The decoder module 124 receives a bitstream, decodes the bitstream, and outputs a decoded video.

The entropy decoding unit 2241 may receive the bitstream including multiple syntax elements from the second interface 126, as shown in FIG. 1, and perform a parsing operation on the bitstream to extract syntax elements from the bitstream. As part of the parsing operation, the entropy decoding unit 2241 may entropy decode the bitstream to generate quantized transform coefficients, quantization parameters, transform data, motion vectors, intra modes, partition information, and/or other syntax information.

The entropy decoding unit 2241 may perform context-adaptive variable length coding (CAVLC), context-adaptive binary arithmetic coding (CABAC), syntax-based context-adaptive binary arithmetic coding (SBAC), probability interval partitioning entropy (PIPE) coding, or another entropy coding technique to generate the quantized transform coefficients. The entropy decoding unit 2241 may provide the quantized transform coefficients, the quantization parameters, and the transform data to the inverse quantization/inverse transform unit 2243 and provide the motion vectors, the intra modes, the partition information, and other syntax information to the prediction processing unit 2242.

The prediction processing unit 2242 may receive syntax elements, such as motion vectors, intra modes, partition information, and other syntax information, from the entropy decoding unit 2241. The prediction processing unit 2242 may receive the syntax elements including the partition information and divide image frames according to the partition information.

Each of the image frames may be divided into at least one image block according to the partition information. The at least one image block may include a luminance block for reconstructing multiple luminance samples and at least one chrominance block for reconstructing multiple chrominance samples. The luminance block and the at least one chrominance block may be further divided to generate macroblocks, coding tree units (CTUs), coding blocks (CBs), sub-divisions thereof, and/or other equivalent coding units.

During the decoding process, the prediction processing unit 2242 may receive predicted data including the intra mode or the motion vector for a current image block of a specific one of the image frames. The current image block may be the luminance block or one of the chrominance blocks in the specific image frame.

The intra prediction unit 22421 may perform intra-predictive coding of a current block unit relative to one or more neighboring blocks in the same frame, as the current block unit, based on syntax elements related to the intra mode in order to generate a predicted block. The intra mode may specify the location of reference samples selected from the neighboring blocks within the current frame. The intra prediction unit 22421 may reconstruct multiple chroma components of the current block unit based on multiple luma components of the current block unit when the multiple chroma components are reconstructed by using the prediction processing unit 2242.

The intra prediction unit 22421 may reconstruct multiple chroma components of the current block unit based on the multiple luma components of the current block unit when the multiple luma components of the current block unit are reconstructed by using the prediction processing unit 2242.

The inter prediction unit 22422 may perform inter-predictive coding of the current block unit relative to one or more blocks in one or more reference image blocks based on syntax elements related to the motion vector in order to generate the predicted block. The motion vector may indicate a displacement of the current block unit within the current image block relative to a reference block unit within the reference image block. The reference block unit may be a block determined to closely match the current block unit. The inter prediction unit 22422 may receive the reference image block stored in the decoded picture buffer 2246 and reconstruct the current block unit based on the received reference image blocks.

The inverse quantization/inverse transform unit 2243 may apply inverse quantization and inverse transformation to reconstruct the residual block in the pixel domain. The inverse quantization/inverse transform unit 2243 may apply inverse quantization to the residual quantized transform coefficient to generate a residual transform coefficient and then apply inverse transformation to the residual transform coefficient to generate the residual block in the pixel domain.

The inverse transformation may be inversely applied by the transformation process, such as a discrete cosine transform (DCT), a discrete sine transform (DST), an adaptive multiple transform (AMT), a mode-dependent non-separable secondary transform (MDNSST), a Hypercube-Givens transform (HyGT), a signal-dependent transform, a Karhunen-Loéve transform (KLT), a wavelet transform, an integer transform, a sub-band transform, or a conceptually similar transform. The inverse transformation may convert the residual information from a transform domain, such as a frequency domain, back to the pixel domain, etc. The degree of inverse quantization may be modified by adjusting a quantization parameter.

The summer 2244 may add the reconstructed residual block to the predicted block provided by the prediction processing unit 2242 to produce a reconstructed block.

The filtering unit 2245 may include a deblocking filter, a sample adaptive offset (SAO) filter, a bilateral filter, and/or an adaptive loop filter (ALF) to remove the blocking artifacts from the reconstructed block. Additional filters (in loop or post loop) may also be used in addition to the deblocking filter, the SAO filter, the bilateral filter, and the ALF. Such filters (are not explicitly illustrated for brevity of the description) may filter the output of the summer 2244. The filtering unit 2245 may output the decoded video to the display module 122 or other video receiving units after the filtering unit 2245 performs the filtering process for the reconstructed blocks of the specific image frame.

The decoded picture buffer 2246 may be a reference picture memory that stores the reference block to be used by the prediction processing unit 2242 in decoding the bitstream (e.g., in inter-coding modes). The decoded picture buffer 2246 may be formed by any one of a variety of memory devices, such as a dynamic random-access memory (DRAM), including synchronous DRAM (SDRAM), magneto-resistive RAM (MRAM), resistive RAM (RRAM), or other types of memory devices. The decoded picture buffer 2246 may be on-chip along with other components of the decoder module 124 or may be off-chip relative to those components.

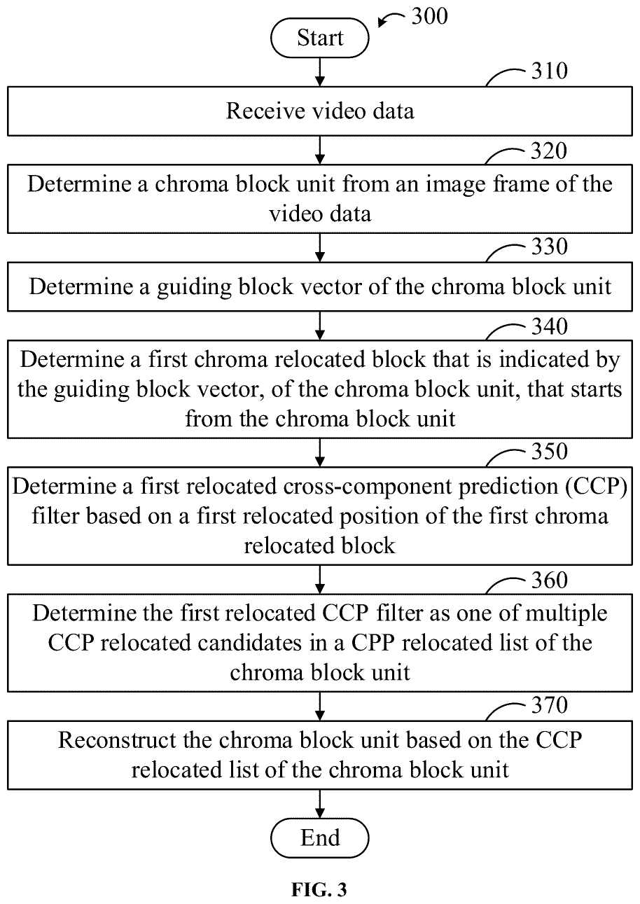

FIG. 3 is a flowchart illustrating a method/process 300 for decoding and/or encoding video data by an electronic device, in accordance with one or more example implementations of this disclosure. The method/process 300 is an example implementation, as there may be a variety of mechanisms of decoding the video data.

The method/process 300 may be performed by an electronic device using the configurations illustrated in FIGS. 1 and/or 2, where various elements of these figures may be referenced to describe the method/process 300. Each block illustrated in FIG. 3 may represent one or more processes, methods, or subroutines performed by an electronic device.

The order in which the blocks appear in FIG. 3 is for illustration only, and may not be construed to limit the scope of the present disclosure, thus the order may be different from what is illustrated. Additional blocks may be added or fewer blocks may be utilized without departing from the scope of the present disclosure.

At block 310, the method/process 300 may start by receiving (e.g., via the decoder module 124, as shown in FIG. 2) the video data. The video data received by the decoder module 124 may include a bitstream.

With reference to FIGS. 1 and 2, the second electronic device 120 may receive the bitstream from an encoder, such as the first electronic device 110 (or other video providers), via the second interface 126.

At block 320, the decoder module 124 may determine a chroma block unit from an image frame of the video data.

With reference to FIGS. 1 and 2, the decoder module 124 may determine the image frames included in the bitstream when the video data, received by the decoder module 124, includes the bitstream. The current frame may be one of the image frames, determined according to the bitstream. The decoder module 124 may further divide the current frame to determine the block unit, according to the partition indications in the bitstream. In some implementations, the decoder module 124 may divide the current frame to generate multiple CTUs, and may further divide a current CTU, included in the CTUs, to generate multiple divided blocks and to determine a block unit from the divided blocks, according to the partition indications (e.g., based on any video coding standard).

In some other implementations, the decoder module 124 may divide the current frame to generate multiple slices or multiple tiles, and further divide a current slice or a current tile, included in the slices or the tiles, to generate multiple CTUs. In addition, the decoder module 124 may further divide a current CTU, included in the CTUs, to generate multiple divided blocks and to determine the block unit from the divided blocks, according to the partition indications.

In some implementations, only one luma block unit may be collocated with the chroma block unit and regarded as a luma collocated block when the chroma block unit is included in a single-tree block unit that is determined from the current frame. In some other implementations, at least one luma block unit may be covered by the luma collocated block that is collocated with the chroma block unit when the chroma block unit is included in a dual-tree block unit. The dual-tree block unit may be determined from the current frame. Since the luma collocated block may be reconstructed prior to the reconstruction of the chroma block unit, a luma block vector may be determined for predicting and reconstructing a portion or all of the luma collocated block of the block unit prior to the reconstruction of the chroma block unit.

The size of the chroma block unit may be Wb×Hb. In some implementations, each of the Wb and Hb may be a positive integer (e.g., four, eight, etc.) that may be the same, or different from the other.

At block 330, the decoder module 124 may determine a guiding block vector of the chroma block unit.

The guiding block vector may be determined based on one of a luma guiding vector and a chroma guiding vector. In some implementations, the luma guiding vector may be a luma reference vector of a luma reference unit covered by the luma collocated block. In some implementations, the chroma guiding vector may be a chroma reference vector of a chroma reference unit selected from multiple chroma adjacent units, multiple chroma non-adjacent units, and multiple chroma temporal units. In some implementations, the luma reference vector of the luma reference unit and the chroma reference vector of the chroma reference unit may be generated by using an intra block copy (IBC) mode, an intra template matching prediction (intraTMP) mode, or a direct block vector (DBV) mode of a video coding standard, including a Versatile Video Coding (VVC) standard. In some other implementations, the chroma guiding vector may be a chroma reference vector of the chroma block unit generated by using the IBC mode, the intraTMP mode, or the DBV mode.

The at least one luma block unit, covered by the luma collocated block, may be reconstructed prior to the reconstruction of the chroma block unit. The luma reference unit having the luma reference vector may be included in the at least one luma block unit. The luma reference unit may cover at least one of multiple luma reference positions of the luma collocated block. The luma reference positions may include a first reference position, located at a top-right corner of the luma collocated block, a second reference position, located at a top-left corner of the luma collocated block, a third reference position, located at a center position of the luma collocated block, a fourth reference position, located at a bottom-left corner of the luma collocated block, and a fifth reference position, located at a bottom-right corner of the luma collocated block.

When a specific one of the at least one luma block unit, which covers at least one of the luma reference positions, is predicted based on a luma block vector, the specific luma block unit may be regarded as the luma reference unit. In addition, the luma block vector of the specific luma block unit may be regarded as the luma reference vector of the luma reference unit. In some implementations, the number of the luma reference vectors, determined based on the at least one luma block unit, may be equal to, or greater than, one. For example, there may be three difference luma reference units covering, respectively, one or more of the luma reference positions, and may be predicted based on a luma block vector. Thus, the number of the luma reference vectors may be equal to three.

When the guiding block vector is determined based on the luma guiding vector, the guiding block vector may be derived using a scaling factor. The scaling factor may be determined based on a video format. In some implementations, if the video format is YUV422, the scaling factor may further include a width scaling factor equal to two and a height scaling factor equal to one. Thus, a horizontal component of the guiding block vector may be equal to one-half of a horizontal component of the luma guiding vector, and a vertical component of the guiding block vector may be equal to a vertical component of the luma guiding vector. In some other implementations, if the video format is YUV420, the scaling factor may further include a width scaling factor of two and a height scaling factor of two. Thus, the horizontal component of the guiding block vector may be equal to one-half of the horizontal component of the luma guiding vector, and the vertical component of the guiding block vector may be equal to one-half of the vertical component of the luma guiding vector.

The chroma reference units, determined from the chroma adjacent units that are adjacent to the chroma block unit, may cover at least one of multiple chroma adjacent positions, respectively. The number of the chroma adjacent positions may be equal to, or greater than, onc. For example, when the number of the chroma adjacent positions is equal to five, the chroma adjacent positions may include a first chroma adjacent position, located above a top-right corner of the chroma block unit, a second chroma adjacent position, located at a left side of a bottom-left corner of the chroma block unit, a third chroma adjacent position, located at a top-right side of the top-right corner of the chroma block unit, a fourth chroma adjacent position, located at a top-left side of a top-left corner of the chroma block unit, and a fifth chroma adjacent position, located at a bottom-left side of a bottom-left corner of the chroma block unit. For example, when the coordinates of the chroma block unit in the image frame are represented as (x, y), the coordinates of the above-described five chroma adjacent positions may be represented, respectively, as (x+Wb−1, y−1), (x−1, y+Hb−1), (x+Wb, y−1), (x−1, y+Hb), and (x−1, y−1).

When a specific one of the chroma adjacent units, which covers at least one of the chroma adjacent positions, is predicted based on a chroma adjacent vector, the specific chroma adjacent unit may be regarded as a chroma reference unit. In addition, the chroma adjacent vector of the specific chroma adjacent unit may be a chroma reference vector of the chroma reference unit.

The chroma reference units, determined from the chroma non-adjacent units, may cover at least one of multiple chroma non-adjacent positions, respectively. The number of the chroma non-adjacent positions may be greater than one.

In some implementations, the chroma non-adjacent positions may be identical to multiple inter non-adjacent positions in an inter merge mode of the video coding standard. In some implementations, the chroma non-adjacent positions may include the first N ones of the inter non-adjacent positions in the inter merge mode of the video coding standard. In some implementations, the number N may be a positive integer. Thus, the number of the chroma non-adjacent positions may be less than, or equal to, the number of the inter non-adjacent positions in the inter merge mode of the video coding standard.

When a specific one of the chroma non-adjacent units, which covers at least one of the chroma non-adjacent positions, is predicted based on a chroma non-adjacent vector, the specific chroma non-adjacent unit may be regarded as a chroma reference unit. In addition, the chroma non-adjacent vector of the specific chroma non-adjacent unit may be a chroma reference vector of the chroma reference unit.

The chroma reference units, determined from the chroma temporal units, may cover at least one of multiple chroma temporal positions, respectively. The number of the chroma temporal positions may be greater than one. The chroma temporal positions may be determined from multiple reference frames in multiple reference picture lists in an inter prediction mode of the video coding standard. The reference picture lists may include a first reference picture list (L0) and a second reference picture list (L1). In addition, the first reference picture list (L0) may include multiple first reference frames, and the second reference picture list (L1) may include multiple second reference frames. The chroma template positions in the first reference picture list (L0) may be determined based on a picture order of the first reference frames in the first reference picture list (L0). In addition, the chroma template positions in the second reference picture list (L1) may be determined based on a picture order of the second reference frames in the second reference picture list (L1).

In some implementations, the chroma temporal positions in the first reference picture list (L0) may be different from the chroma temporal positions in the second reference picture list (L1). In some implementations, the chroma temporal positions may be identical to multiple inter temporal positions in the inter merge mode of the video coding standard.

When a specific one of the chroma temporal units, which covers at least one of the chroma temporal positions, is predicted based on a chroma temporal vector, the specific chroma temporal unit may be regarded as a chroma reference unit. In addition, the chroma temporal vector of the specific chroma temporal unit may be a chroma reference vector of the chroma reference unit.

Referring back to FIG. 3, at block 340, the decoder module 124 may determine a first chroma relocated block that is indicated by the guiding block vector, of the chroma block unit, that starts from the chroma block unit.

The first chroma relocated block may be indicated by the guiding block vector, of the chroma block unit, that starts from one of multiple guiding start positions of the chroma block unit to one of multiple guiding end positions for determining the first chroma relocated block.

The guiding start positions may be predefined in the first electronic device 110 and the second electronic device 120. The number of the guiding start positions may be equal to, or greater than, one. For example, when the number of the guiding start positions is equal to five, the guiding start positions may include a first guiding start position C1, located at the center position of the chroma block unit, a second guiding start position AL1, located at the top-left corner of the chroma block unit, a third guiding start position AR1, located at the top-right corner of the chroma block unit, a fourth guiding start position BL1, located at the bottom-left corner of the chroma block unit, and a fifth guiding start position BR1, located at a bottom-right corner of the chroma block unit. For example, when the coordinates of the chroma block unit in the image frame are (x, y), the coordinates of the five guiding start positions may, respectively, be C1 (x+ ((Wb−1)/2), y+ ((Hb−1)/2)), AL1 (x, y), AR1 (x+Wb−1, y), BL1 (x, y+Hb−1), and BR1 (x+Wb−1, y+Hb−1). In some other implementations, the coordinates of the five guiding start positions may, respectively, be C1 (x+ (Wb/2), y+ (Hb/2)), AL1 (x, y), AR1 (x+Wb−1, y), BL1 (x, y+Hb−1), and BR1 (x+Wb−1, y+Hb−1).

In some implementations, a search order of the guiding start positions for determining the first chroma relocated block may be predefined in the first electronic device 110 and the second electronic device 120. For example, when the number of the guiding start positions is equal to five, the five guiding start positions for determining the first chroma relocated block may be sequentially ordered from the first guiding start position to the fifth guiding start position. In other words, the search order of the guiding start positions for determining the first chroma relocated block may be sequentially arranged as C1, AL1, AR1, BL1, and BR1.

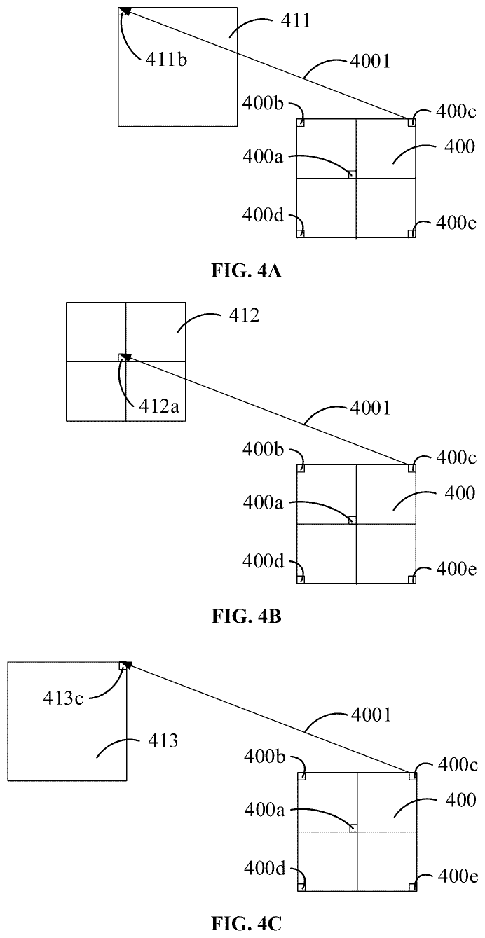

FIGS. 4A-4C are schematic diagrams illustrating different chroma relocated blocks that are indicated by the same guiding block vector that starts from the same guiding start position to different guiding end positions, in accordance with one or more example implementations of this disclosure. FIG. 4A illustrates the first chroma relocated block 411 that is indicated by the guiding block vector 4001, of the chroma block unit 400, that starts from the guiding start position 400c to the guiding end position 411b. In FIG. 4A, the chroma block unit 400 may cover the first guiding start position 400a, the second guiding start position 400b, the third guiding start position 400c, the fourth guiding start position 400d, and the fifth guiding start position 400c. In order to determine the first chroma relocated block 411, the decoder module 124 may select one of the guiding start positions 400a-400e, as a start point of the guiding block vector 4001. For example, in FIG. 4A, the start point of the guiding block vector 4001 may be the third guiding start position 400c for determining the first chroma relocated block 411.

The guiding end positions may be included in the first chroma relocated block. A size of the first chroma relocated block may be identical to the size Wb×Hb of the chroma block unit. The location of the first chroma relocated block may be determined based on the size Wb×Hb of the chroma block unit and the spatial relationship between the guiding end position and the first chroma relocated block. A method for determining the spatial relationship between the guiding end position and the first chroma relocated block may be predefined in the first electronic device 110 and the second electronic device 120.

In some implementations, the guiding end position may be predefined as a top-left corner of the first chroma relocated block. Thus, the guiding end position may be first determined based on the guiding block vector and the guiding start position of the chroma block unit. Then, the first chroma relocated block may be determined by extending a block from the guiding end position in a bottom-right direction to generate an intermediate block that has the same size, as the chroma block unit. The intermediate block, covering the guiding end position, which is located at a top-left corner of the intermediate block, can be regarded as the first chroma relocated block. For example, the guiding end position 411b may be first determined based on the guiding block vector 4001 and the guiding start position 400c of the chroma block unit 400. Since the guiding end position 411b is predefined to be located at the top-left corner of the first chroma relocated block 411, the decoder module 124 may extend a block from the guiding end position 411b in the bottom-right direction to generate the first chroma relocated block 411. In addition, the first chroma relocated block 411 may have the same size, as the chroma block unit 400.

In some other implementations, the guiding end position may be predefined, as a center position of the first chroma relocated block. Thus, the guiding end position may be first determined based on the guiding block vector and the guiding start position of the chroma block unit. Then, the first chroma relocated block may be determined by uniformly extending a block from the guiding end position in all directions to generate an intermediate block that has the same size, as the chroma block unit. The intermediate block, covering the guiding end position, which is located at a center position of the intermediate block, can be regarded as the first chroma relocated block.

FIG. 4B illustrates the first chroma relocated block 412 that is indicated by the guiding block vector 4001, of the chroma block unit 400, that starts from the guiding start position 400c to the guiding end position 412a. In order to determine the first chroma relocated block 412, the decoder module 124 may select one of the guiding start positions 400a-400c, as the start point of the guiding block vector 4001. For example, in FIG. 4B, the start point of the guiding block vector 4001 may be the third guiding start position 400c, for determining the first chroma relocated block 411. The guiding end position 412a may be first determined based on the guiding block vector 4001 and the guiding start position 400c of the chroma block unit 400. Since the guiding end position 411b is predefined to be located at the center position of the first chroma relocated block 411, the decoder module 124 may uniformly extend a block from the guiding end position 412a in all directions to generate the first chroma relocated block 412. In addition, the first chroma relocated block 411 may have the same size, as the chroma block unit 400.

In yet some other implementations, the spatial relationship between the guiding end position and the first chroma relocated block may be identical to the spatial relationship between the guiding start position and the chroma block unit. Thus, the guiding end position may be first determined based on the guiding block vector and the guiding start position of the chroma block unit. Then, the first chroma relocated block may be determined by extending a block from the guiding end position based on the spatial relationship between the guiding start position and the chroma block unit to generate an intermediate block. The intermediate block may have the same size, as the chroma block unit. In addition, for example, when the guiding start position is located at the bottom-right side of the chroma block unit, the guiding end position may be located at a bottom-right side of the first chroma relocated block.

FIG. 4C illustrates the first chroma relocated block 413 that is indicated by the guiding block vector 4001, of the chroma block unit 400, that starts from the guiding start position 400c to the guiding end position 413c. In order to determine the first chroma relocated block 413, the decoder module 124 may select one of the guiding start positions 400a-400e, as the start point of the guiding block vector 4001. For example, in FIG. 4C, the start point of the guiding block vector 4001 may be the third guiding start position 400c, located at the top-right corner of the chroma block unit 400, for determining the first chroma relocated block 413. The guiding end position 413c may be first determined based on the guiding block vector 4001 and the guiding start position 400c of the chroma block unit 400. Since the spatial relationship between the guiding end position and the first chroma relocated block may be identical to the spatial relationship between the guiding start position and the chroma block unit, the decoder module 124 may extend a block from the guiding end position 413c based on the spatial relationship between the guiding end position 413c and the chroma block unit 413 to generate the first chroma relocated block 413. In FIG. 4C, the decoder module 124 may extend the block from the guiding end position 413c in the bottom-left direction to generate the first chroma relocated block 413 that has the same size, as the chroma block unit 400. Thus, guiding end position 413c may be located at the top-right corner of the first chroma relocated block 413.

Referring back to FIG. 3, at block 350, the decoder module 124 may determine a first relocated cross-component prediction (CCP) filter based on a first relocated position of the first chroma relocated block.

The decoder module 124 may determine one or more chroma relocated units, each associated with the first chroma relocated block. Each of the one or more chroma relocated units may be partly or fully covered by the first chroma relocated block.

The decoder module 124 may determine multiple chroma relocated positions in the first chroma relocated block. The number of the chroma relocated positions in the first chroma relocated block may be equal to, or greater than, one. For example, when the number of the chroma relocated positions in the first chroma relocated block is equal to five, the chroma relocated positions in the first chroma relocated block may include a first chroma relocated position C2, located at a center position of the first chroma relocated block, a second chroma relocated position AL2, located at a top-left corner of the first chroma relocated block, a third chroma relocated position AR2, located at a top-right corner of the first chroma relocated block, a fourth chroma relocated position BL2, located at a bottom-left corner of the first chroma relocated block, and a fifth chroma relocated position BR2, located at a bottom-right corner of the first chroma relocated block. For example, when the coordinates of the first chroma relocated block in the image frame is (a, b), the coordinates of the five chroma relocated positions may be, respectively, C2 (a+((Wb−1)/2), b+ ((Hb−1)/2)), AL2 (a, b), AR2 (a+Wb−1, b), BL2 (a, b+Hb−1), and BR2 (a+Wb−1, b+Hb−1). In some other implementations, the coordinates of the five chroma relocated positions may, respectively, be C2 (a+(Wb/2), b+ (Hb/2)), AL2 (a, b), AR2 (a+Wb−1, b), BL2 (a, b+Hb−1), and BR2 (a+Wb−1, b+Hb−1).

In some implementations, a search order of the chroma relocated positions for determining a relocated CCP filter may be predefined in the first electronic device 110 and the second electronic device 120. For example, when the number of the chroma relocated positions is equal to five, the five chroma relocated positions for determining the relocated CCP filter may be sequentially ordered from the first chroma relocated position to the fifth chroma relocated position. In other words, the search order of the chroma relocated positions for determining the relocated CCP filter may be sequentially arranged, as C2, AL2, AR2, BL2, and BR2.

Since the at least one chroma relocated unit is reconstructed prior to the reconstruction of the chroma block unit, the decoder module 124 may determine at least one chroma relocated prediction mode of the at least one chroma relocated unit. The chroma relocated prediction mode may be one of a CCP prediction mode, an intraTMP mode, an IBC mode, a DBV mode, a Planar mode, a DC mode, a chroma directional mode, a decoder-side intra mode derivation (DIMD) mode, and a direct mode (DM).

When a first one of the at least one chroma relocated unit, which covers a first relocated position of the chroma relocated positions in the first chroma relocated block, is reconstructed by using the CCP prediction mode, the first chroma relocated unit may be reconstructed by using a first relocated CCP filter. Thus, the first relocated CCP filter may be determined based on the first relocated position of the first chroma relocated block. The first relocated CCP filter of the first chroma relocated unit may be used to predict the chroma block unit.

When a second one of the at least one chroma relocated unit, which covers a second relocated position of the chroma relocated positions in the first chroma relocated block, is also reconstructed by using the CCP prediction mode, the second chroma relocated unit may be reconstructed by using a second relocated CCP filter. Thus, the second relocated CCP filter may be determined based on the second relocated position of the first chroma relocated block. The second relocated CCP filter of the second chroma relocated unit may be used to predict the chroma block unit.

When a third one of the at least one chroma relocated unit, which covers a third relocated position of the chroma relocated positions in the first chroma relocated block, is reconstructed by using a block vector prediction mode, the third chroma relocated unit may be reconstructed by using a first relocated block vector. Thus, the first relocated block vector may be determined based on the third relocated position of the first chroma relocated block. The first relocated block vector may be used to determine a second chroma relocated block that is indicated by the first relocated block vector that starts from the first chroma relocated block. In some implementations, the block vector prediction mode may include the IBC mode, the intraTMP mode, and the DBV mode.

The first to the third chroma relocated units may be different from each other. In addition, the first to the third chroma relocated positions may also be different from each other.

The second chroma relocated block may be indicated by the first relocated block vector, of the third chroma relocated unit, that starts from a first relocated start position in the first chroma relocated block to a first relocated end position in the second chroma relocated block. The method for determining the first relocated start position in the first chroma relocated block and the first relocated end position in the second chroma relocated block may be predefined in the first electronic device 110 and the second electronic device 120.

When the decoder module 124 determines the second chroma relocated block, the decoder module 124 may select one of multiple first relocated start positions in the first chroma relocated block, as a start point of the first relocated block vector, to indicate the second chroma relocated block. The number of the first relocated start positions may be equal to, or greater than, one. In some implementations, the first relocated start positions in the first chroma relocated block may be identical to the chroma relocated positions in the first chroma relocated block.

In some implementations, a specific one of the first relocated start positions, which is selected as the start point of the first relocated block vector, may be identical to a specific one of the chroma relocated positions in the first chroma relocated block. The specific chroma relocated position in the first chroma relocated block may be covered by a specific one of the chroma relocated units, which has the first relocated block vector. Thus, the specific first relocated start position, used as the start point of the first relocated block vector, may be identical to the third relocated position in the first chroma relocated block. In addition, the third chroma relocated unit, covering the third relocated position in the first chroma relocated block, may be reconstructed by using the first relocated block vector.

The first relocated end position of the first relocated block vector may be included in the second chroma relocated block. A size of the second chroma relocated block may be identical to the size Wb×Hb of the chroma block unit. The second chroma relocated block may be determined based on the size Wb×Hb of the chroma block unit and the spatial relationship between the second chroma relocated block and the first relocated end position of the first relocated block vector. A method for determining the spatial relationship between the second chroma relocated block and the first relocated end position of the first relocated block vector may be predefined in the first electronic device 110 and the second electronic device 120.

In some implementations, the first relocated end position of the first relocated block vector may be predefined, as a center position of the second chroma relocated block. The first relocated end position of the first relocated block vector may be determined, as the center position of the second chroma relocated block. Thus, the second chroma relocated block may be determined based on the center position of the second chroma relocated block and the size Wb×Hb of the chroma block unit.

The first relocated end position of the first relocated block vector may be first determined based on the first relocated block vector and the first relocated start position of the first relocated block vector. Then, the second chroma relocated block may be determined by uniformly extending a block from the first relocated end position in all directions to generate an intermediate block that has the same size, as the chroma block unit. The intermediate block, covering the first relocated end position, which is located at a center position of the intermediate block, can be regarded as the second chroma relocated block.

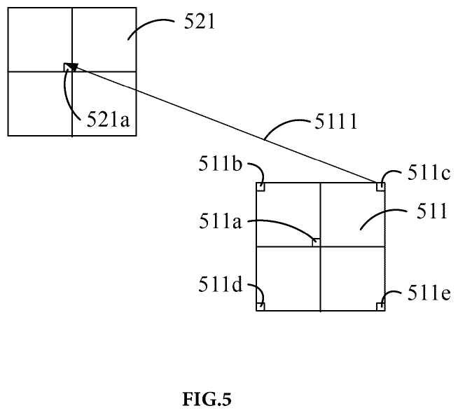

FIG. 5 is a schematic diagram illustrating a second chroma relocated block 521 that is indicated by a first relocated block vector 5111, in accordance with one or more example implementations of this disclosure. The first chroma relocated block 511 may cover a first chroma relocated position 511a, the second chroma relocated position 511b, the third chroma relocated position 511c, the fourth chroma relocated position 511d, and the fifth chroma relocated position 511c.

In some implementations, the first chroma relocated block 511 may further cover five relocated start positions. In some implementations, the five relocated start positions may be identical to the first to fifth chroma relocated positions 511a-511e. In order to determine the second chroma relocated block, the decoder module 124 may select one of the relocated start positions, as a start point of the first relocated block vector 5111. For example, when the first relocated block vector 5111 in FIG. 5 is determined based on the third chroma relocated unit covering the third chroma relocated position 511c, one of the relocated start positions, which is identical to the third chroma relocated position 511c, may be selected, as the first relocated start position of the first relocated block vector 5111. Thus, when the decoder module 124 determines the second chroma relocated block 521, the third chroma relocated position 511c may be selected, as the first relocated start position of the first relocated block vector 5111.

Since the first relocated end position is predefined to be located at the center position of the second chroma relocated block, the decoder module 124 may uniformly extend a block from the first relocated end position 521a in all directions to generate the second chroma relocated block 521. In addition, the second chroma relocated block 521 may have the same size, as the first chroma relocated block 511.

The decoder module 124 may further determine at least one chroma relocated unit, each associated with the second chroma relocated block. Each of the at least one chroma relocated unit that is associated with the second chroma relocated block may be partly, or fully, covered by the second chroma relocated block.

The decoder module 124 may determine multiple chroma relocated positions in the second chroma relocated block. The spatial relationship between the second chroma relocated block and the chroma relocated positions within the second chroma relocated block may be identical to the spatial relationship between the first chroma relocated block and the chroma relocated positions within the first chroma relocated block. For example, when the coordinates of the second chroma relocated block in the image frame is (c, d), the coordinates of the five chroma relocated positions may, respectively, be C3 (c+ ((Wb−1)/2), d+ ((Hb−1)/2)), AL3 (c, d), AR3 (c+Wb−1, d), BL3 (c, d+Hb−1), and BR3 (c+Wb−1, d+Hb−1). In some other implementations, the coordinates of the five chroma relocated positions may, respectively, be C3 (c+ (Wb/2), d+ (Hb/2)), AL3 (c, d), AR3 (c+Wb−1, d), BL3 (c, d+Hb−1), and BR3 (c+Wb−1, d+Hb−1).

In some implementations, a search order of the chroma relocated positions in the second chroma relocated block for determining a relocated CCP filter may be predefined in the first electronic device 110 and the second electronic device 120. For example, when the number of the chroma relocated positions in the second chroma relocated block is equal to five, the five chroma relocated positions in the second chroma relocated block may be sequentially ordered from the first chroma relocated position to the fifth chroma relocated position. In other words, the search order of the chroma relocated positions in the second chroma relocated block for determining the relocated CCP filter may be sequentially arranged as C3, AL3, AR3, BL3, and BR3.

Since the at least one chroma relocated unit, associated with the second chroma relocated block, is reconstructed prior to the reconstruction of the chroma block unit, the decoder module 124 may determine at least one chroma relocated prediction mode of the at least one chroma relocated unit. The chroma relocated prediction mode may be one of a CCP prediction mode, an intraTMP mode, an IBC mode, a DBV mode, a Planar mode, a DC mode, a chroma directional mode, a DIMD mode, and a DM.

The decoder module 124 may determine a third relocated CCP filter based on the at least one chroma relocated unit, associated with the second chroma relocated block.

When a first one of the at least one chroma relocated unit, which covers a first relocated position of the chroma relocated positions in the second chroma relocated block, is reconstructed by using the CCP prediction mode, the first chroma relocated unit may be reconstructed by using a third relocated CCP filter. The third relocated CCP filter may be determined based on the first relocated position of the second chroma relocated block. The third relocated CCP filter of the first chroma relocated unit may be used to predict the chroma block unit.

When a second one of the at least one chroma relocated unit, which covers a second relocated position of the chroma relocated positions in the second chroma relocated block, is reconstructed by using the block vector prediction mode, the second chroma relocated unit may be reconstructed by using a second relocated block vector. Thus, the second relocated block vector may be determined based on the second relocated position that is associated with the second chroma relocated block. The second relocated block vector may be used to determine a third chroma relocated block that is indicated by the second relocated block vector that starts from the second chroma relocated block.

The decoder module 124 may determine an (N−1)-th relocated block vector based on a relocated position of an (N−1)-th chroma relocated block. In addition, the decoder module 124 may determine an N-th chroma relocated block that is indicated by the (N−1)-th relocated block vector, of a chroma relocated unit of the (N−1)-th chroma relocated block, that starts from a (N−1)-th relocated start position in the (N−1)-th chroma relocated block to another (N−1)-th relocated end position. The method for determining the (N−1)-th relocated start position in the (N−1)-th chroma relocated block may be predefined in the first electronic device 110 and the second electronic device 120. In some implementations, the number N may be a relocated level of the N-th chroma relocated block. In some implementations, the number N may be a positive integer, equal to, or greater than, two.

When the decoder module 124 determines the N-th chroma relocated block, the decoder module 124 may select one of multiple (N−1)-th relocated start positions in the (N−1)-th chroma relocated block as a start point of the (N−1)-th relocated block vector to indicate the N-th chroma relocated block. The number of the (N−1)-th relocated start positions in the (N−1)-th chroma relocated block may be equal to, or greater than, one. In some implementations, the (N−1)-th relocated start positions in the (N−1)-th chroma relocated block may be identical to the chroma relocated positions in the (N−1)-th chroma relocated block.

In some implementations, a specific one of the (N−1)-th relocated start positions, which is selected as the start point of the (N−1)-th relocated block vector, may be identical to a specific one of the chroma relocated positions in the (N−1)-th chroma relocated block. The specific (N−1)-th chroma relocated position in the (N−1)-th chroma relocated block may be covered by a specific one of the chroma relocated units, which has the (N−1)-th relocated block vector. Thus, the specific (N−1)-th relocated start position, used as the start point of the (N−1)-th relocated block vector, may be identical to the specific (N−1)-th chroma relocated position in the (N−1)-th chroma relocated block. In addition, the specific chroma relocated unit, covering the (N−1)-th relocated position in the (N−1)-th chroma relocated block, may be reconstructed by using the (N−1)-th relocated block vector.

The (N−1)-th relocated end position of the (N−1)-th relocated block vector may be included in the N-th chroma relocated block. A size of the N-th chroma relocated block may be identical to the size Wb×Hb of the chroma block unit. The N-th chroma relocated block may be determined based on the size Wb×Hb of the chroma block unit and the spatial relationship between the N-th chroma relocated block and the (N−1)-th relocated end position of the (N−1)-th relocated block vector. A method for determining the spatial relationship between the N-th chroma relocated block and the (N−1)-th relocated end position of the (N−1)-th relocated block vector may be predefined in the first electronic device 110 and the second electronic device 120.

In some implementations, the (N−1)-th relocated end position of the (N−1)-th relocated block vector may be predefined as a center position of the N-th chroma relocated block. The (N−1)-th relocated end position of the (N−1)-th relocated block vector may be determined as the center position of the N-th chroma relocated block. Thus, the N-th chroma relocated block may be determined based on the center position of the N-th chroma relocated block and the size Wb×Hb of the chroma block unit.

The (N−1)-th relocated end position of the (N−1)-th relocated block vector may be first determined based on the (N−1)-th relocated block vector and the (N−1)-th relocated start position of the (N−1)-th relocated block vector. Then, the N-th chroma relocated block may be determined by uniformly extending a block from the (N−1)-th relocated end position in all directions to generate an intermediate block that has the same size, as the chroma block unit. The intermediate block, covering the (N−1)-th relocated end position, which is located at a center position of the intermediate block, can be regarded as the N-th chroma relocated block.

The decoder module 124 may further determine at least one chroma relocated unit, each associated with the N-th chroma relocated block. Each of the at least one chroma relocated unit may be partly or fully covered by the N-th chroma relocated block.

The decoder module 124 may determine multiple chroma relocated positions in the N-th chroma relocated block. The spatial relationship between the N-th chroma relocated block and the chroma relocated positions within the N-th chroma relocated block may be identical to the spatial relationship between the (N−1)-th chroma relocated block and the chroma relocated positions within the (N−1)-th chroma relocated block.

Since the at least one chroma relocated unit, associated with the N-th chroma relocated block, is reconstructed prior to the reconstruction of the chroma block unit, the decoder module 124 may determine at least one chroma relocated prediction mode of the at least one chroma relocated unit. The chroma relocated prediction mode associated with the N-th chroma relocated block may be one of a CCP prediction mode, an intraTMP mode, an IBC mode, a DBV mode, a Planar mode, a DC mode, a chroma directional mode, a DIMD mode, and a DM.

The decoder module 124 may determine a K-th relocated CCP filter based on the at least one chroma relocated unit, associated with the N-th chroma relocated block. In some implementations, the number K may be an integer, equal to, or greater than one. In some implementations, the number K may be equal to, or different from, the number N.

When a first one of the at least one chroma relocated unit, which covers a first relocated position of the chroma relocated positions in the N-th chroma relocated block, is reconstructed by using the CCP prediction mode, the first chroma relocated unit may be reconstructed by using the K-th relocated CCP filter. The K-th relocated CCP filter may be determined based on the first relocated position of the N-th chroma relocated block. The K-th relocated CCP filter of the first chroma relocated unit may be used to predict the chroma block unit.

When a second one of the at least one chroma relocated unit, which covers a second relocated position of the chroma relocated positions in the N-th chroma relocated block, is reconstructed by using the block vector prediction mode, the second chroma relocated unit may be reconstructed by using an N-th relocated block vector. Thus, the N-th relocated block vector may be determined based on the second relocated position associated with the N-th chroma relocated block. The N-th relocated block vector may be used to determine an (N+1)-th chroma relocated block that is indicated by the N-th relocated block vector that starts from the N-th chroma relocated block.

In some implementations, the decoder module 124 may keep determining whether the at least one chroma relocated unit is reconstructed by using the block vector prediction mode when the relocated level of the N-th chroma relocated block equal to N is less than a relocated level threshold. In some other implementations, the decoder module 124 may stop determining whether the at least one chroma relocated unit is reconstructed by using the block vector prediction mode when the relocated level of the N-th chroma relocated block equal to N is equal to the relocated level threshold. In some implementations, the relocated level threshold may be predefined in the first electronic device 110 and the second electronic device 120. In some implementations, the relocated level threshold may be equal to two, three, or four.

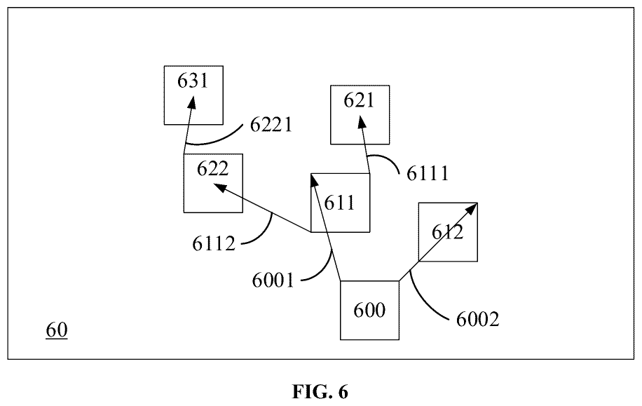

FIG. 6 is a schematic diagram illustrating multiple chroma relocated blocks that are indicated by multiple relocated block vectors and that are in different relocated levels, in accordance with one or more example implementations of this disclosure. In FIG. 6, the relocated level threshold may be equal to, or greater than, three. In some implementations, the decoder module 124 may determine the third chroma relocated block without further determining the fourth chroma relocated block. In some other implementations, the decoder module 124 may merely determine the third chroma relocated block since there is no chroma relocated unit, covering at least one of multiple chroma relocated positions in the third chroma relocated block and reconstructed by using the block vector prediction mode.

The decoder module 124 may search for the guiding block vectors for the chroma block unit 600. In FIG. 6, the decoder module 124 may determine two different guiding block vectors 6001 and 6002 for the chroma block unit 600.

The first chroma relocated block 611 may be indicated by the guiding block vector 6001 that starts from the top-left corner of the chroma block unit 600 to the top-left corner of the first chroma relocated block 611. Then, the decoder module 124 may search for the relocated CCP filters based on the chroma relocated positions in the first chroma relocated block 611. In addition, the decoder module 124 may also search for a first relocated block vector based on the chroma relocated positions in the first chroma relocated block 611. In FIG. 6, the decoder module 124 may determine two first relocated block vectors 6111 and 6112.

The second chroma relocated block 621 may be indicated by the first relocated block vector 6111 that starts from the top-right corner of the first chroma relocated block 611 to the center point of the second chroma relocated block 621. Then, the decoder module 124 may search for the relocated CCP filters based on the chroma relocated positions in the second chroma relocated block 621. In addition, the decoder module 124 may also search for a second relocated block vector based on the chroma relocated positions in the second chroma relocated block 621. In FIG. 6, the decoder module 124 may determine no second relocated block vector based ib the chroma relocated positions of the second chroma relocated block 621.

The second chroma relocated block 622 may be indicated by the first relocated block vector 6112 that starts from the bottom-left corner of the first chroma relocated block 611 to the center point of the second chroma relocated block 622. Then, the decoder module 124 may search for the relocated CCP filters based on the chroma relocated positions in the second chroma relocated block 622. In addition, the decoder module 124 may also search for a second relocated block vector based on the chroma relocated positions in the second chroma relocated block 622. In FIG. 6, the decoder module 124 may determine a second relocated block vector 6221.

The third chroma relocated block 631 may be indicated by the second relocated block vector 6221 that starts from the top-left corner of the second chroma relocated block 622 to the center point of the third chroma relocated block 631. Then, the decoder module 124 may search for the relocated CCP filters based on the chroma relocated positions in the third chroma relocated block 631. In some implementations, the decoder module 124 may also search for a third relocated block vector based on the chroma relocated positions in the third chroma relocated block 631. In FIG. 6, the decoder module 124 may determine no third relocated block vector based on the chroma relocated positions of the third chroma relocated block 631. In some other implementations, the decoder module 124 may not further search for a third relocated block vector based on the chroma relocated positions in the third chroma relocated block 621 when the relocated level threshold is equal to three.

In some implementations, after a search loop of searching for the relocated CCP filters based on the top-left corner of the chroma block unit 600 ends, the decoder module 124 may start to search for the relocated CCP filters based on the top-right corner of the chroma block unit 600. The first chroma relocated block 612 may be indicated by the guiding block vector 6002 that starts from the top-right corner of the chroma block unit 600 to the top-right corner of the first chroma relocated block 612. Then, the decoder module 124 may search for the relocated CCP filters based on the chroma relocated positions in the first chroma relocated block 612. In addition, the decoder module 124 may also search for the first relocated block vector based on the chroma relocated positions in the first chroma relocated block 612. In FIG. 6, the decoder module 124 may determine no first relocated block vector based on the chroma relocated positions of the first chroma relocated block 612.

Referring back to FIG. 3, at block 360, the decoder module 124 may determine the first relocated CCP filter as one of a plurality of CCP relocated candidates in a CPP relocated list of the chroma block unit.

The decoder module 124 may determine the CCP relocated list of the chroma block unit for predicting and/or reconstructing the chroma block unit. The CCP relocated list may include the CCP relocated candidates.

When the decoder module 124 determines a first chroma relocated unit, reconstructed by using the CCP prediction mode and covering a first relocated position in the first chroma relocated block, the first chroma relocated unit, covering the first relocated position, may be reconstructed by using the first relocated CCP filter. The first relocated CCP filter of the first chroma relocated unit may be added into the CCP relocated list of the chroma block unit as one of the CCP relocated candidates.

When the decoder module 124 determines a second chroma relocated unit, reconstructed by using the CCP prediction mode and covering a second relocated position in the first chroma relocated block, the second chroma relocated unit, covering the second relocated position, may be reconstructed by using the second relocated CCP filter. The second relocated CCP filter of the second chroma relocated unit may be added into the CCP relocated list of the chroma block unit as one of the CCP relocated candidates.

When the decoder module 124 determines a third chroma relocated unit, reconstructed by using the CCP prediction mode and covering a first relocated position in the second chroma relocated block, the third chroma relocated unit, covering the first relocated position in the second chroma relocated block, may be reconstructed by using the third relocated CCP filter. The third relocated CCP filter of the third chroma relocated unit may be added into the CCP relocated list of the chroma block unit as one of the CCP relocated candidates.

When the decoder module 124 determines a fourth chroma relocated unit, reconstructed by using the CCP prediction mode and covering a first relocated position in the N-th chroma relocated block, the fourth chroma relocated unit, covering the first relocated position in the N-th chroma relocated block, may be reconstructed by using the K-th relocated CCP filter. The K-th relocated CCP filter of the fourth chroma relocated unit may also be added into the CCP relocated list of the chroma block unit as one of the CCP relocated candidates.

The number of the CCP relocated candidates in the CCP relocated list may be equal to, or less than, a relocated quantity threshold. In some implementations, the relocated quantity threshold may be predefined in the first electronic device 110 and the second electronic device 120. In some implementations, the relocated quantity threshold may be equal to twenty.

In some implementations, the CCP relocated candidates in the CCP relocated list may be added in a CCP merge list. In other words, the CCP relocated list may be partly or fully included in the CCP merge list. The CCP merge list of the chroma block unit for predicting and/or reconstructing the chroma block unit may include multiple CCP merge candidates. In some implementations, the relocated quantity threshold may be equal to, or less than, a CCP merge quantity threshold of the CCP merge list. In some implementations, at least one of the CCP relocated candidates may be included in the CCP merge candidates of the CCP merge list of the chroma block unit. In some other implementations, the relocated quantity threshold may be less than an intra merge quantity threshold of an intra merge list.

In some other implementations, the CCP relocated candidates may be added in the CCP relocated list, but not be added in the CCP merge list. In other words, the CCP relocated list may be separated from the CCP merge list. In some implementations, the bitstream may include a CCP relocated mode flag, and the CCP relocated mode flag may be used to indicate whether the CCP relocated candidates in the CCP relocated list are included in the CCP merge list. The CCP relocated mode flag may be signaled in a chroma syntax structure.

The CCP merge list may include at least one of multiple CCP adjacent candidates, multiple CCP non-adjacent candidates, multiple CCP temporal candidates, and multiple CCP history-based candidates. In some implementations, when a specific one of the chroma adjacent units, which covers at least one of the chroma adjacent positions, is predicted based on the CCP prediction mode, the specific chroma adjacent unit may be regarded as one of multiple CCP adjacent units. In addition, a CCP prediction filter of the chroma adjacent unit may be regarded as one of the CCP adjacent candidates.

In some implementations, when a specific one of the chroma non-adjacent units, which covers at least one of the chroma non-adjacent positions, is predicted based on the CCP prediction mode, the specific chroma non-adjacent unit may be regarded as one of multiple CCP non-adjacent units. In addition, a CCP prediction filter of the chroma non-adjacent unit may be regarded as one of the CCP non-adjacent candidates.

In some implementations, when a specific one of the chroma temporal units, which covers at least one of the chroma temporal positions, is predicted based on the CCP prediction mode, the specific chroma temporal unit may be regarded as one of multiple CCP temporal units. In addition, a CCP prediction filter of the chroma temporal unit may be regarded as one of the CCP temporal candidates.

In some implementations, the CCP history-based candidates may include multiple CCP prediction filters in a history-based cross-component linear model (H-CCLM) table. In some implementations, the size of H-CCLM table may be equal to six. When a previously-decoded block unit is decoded by the CCP prediction mode, the CCP prediction filter of the previously-decoded block unit may be stored in the H-CCLM table based on a first-in-first-out (FIFO) basis. In some implementations, the H-CCLM table may be reset at the beginning of each CTU row.

In some implementations, the CCP relocated candidates may be derived when the derivation of the CCP adjacent candidates, and the CCP non-adjacent candidates, the CCP temporal candidates, the CCP history-based candidate has ended.

In some other implementations, the CCP relocated candidates may include multiple CCP relocated adjacent candidates, multiple relocated non-adjacent candidates, and multiple CCP relocated temporal candidates. In addition, the CCP relocated adjacent candidates may be derived immediately after the derivation of the CCP adjacent candidates has completed. The CCP relocated non-adjacent candidates may be derived immediately after the derivation of the CCP non-adjacent candidates has completed. The CCP relocated temporal candidates may be derived immediately after the derivation of the CCP temporal candidates has completed.

In the implementations, the relocated CCP filter of a chroma relocated unit may be determined as one of the CCP relocated adjacent candidates, when the chroma relocated unit, predicted based on the relocated CCP filter, is determined based on a chroma adjacent vector, used to predict one of the chroma adjacent units. The relocated CCP filter of a chroma relocated unit may be determined as one of the CCP relocated non-adjacent candidates, when the chroma relocated unit, predicted based on the relocated CCP filter, is determined based on a chroma non-adjacent vector, used to predict one of the chroma non-adjacent units. The relocated CCP filter of a chroma relocated unit may be determined as one of the CCP relocated temporal candidates, when the chroma relocated unit, predicted based on the relocated CCP filter, is determined based on a chroma temporal vector, used to predict one of the chroma temporal units.

In some implementations, the decoder module 124 may keep determining whether the at least one chroma relocated unit is reconstructed by using the CCP prediction mode when the number of the added CCP relocated candidates in the CCP relocated list is still less than the relocated quantity threshold. In some other implementations, the decoder module 124 may stop determining whether the at least one chroma relocated unit is reconstructed by using the CCP prediction mode when the number of the added CCP relocated candidates in the CCP relocated list has been equal to the relocated quantity threshold.

Referring back to FIG. 3, at block 370, the decoder module 124 may reconstruct the chroma block unit based on the CCP relocated list of the chroma block unit.

With reference to FIGS. 1 and 2, in some implementations, the decoder module 124 may determine a chroma candidate list of the chroma block unit for reconstructing the chroma block unit. In some implementations, the chroma candidate list may include multiple chroma prediction candidates, selected from at least one of the CCP relocated candidates, or other chroma prediction candidates.

The decoder module 124 may select a chroma prediction mode from the chroma prediction candidates to reconstruct the chroma block unit. In some implementations, the decoder module 124 may select the chroma prediction mode from the chroma prediction candidates based on a chroma prediction index. In some other implementations, the decoder module 124 may select the chroma prediction mode from the CCP merge candidates based on a CCP merge index. In yet some other implementations, the decoder module 124 may select the chroma prediction mode from the CCP relocated candidates based on a CCP relocated index. Thus, the decoder module 124 may select one of the CCP relocated candidates in the CCP relocated list of the chroma block unit.

In some implementations, the decoder module 124 may then predict the chroma block unit using the selected CCP relocated candidate based on the luma collocated block, collocated with the chroma block unit, to generate a chroma predicted block.

In some other implementations, the decoder module 124 may predict the chroma block unit using the selected CCP relocated candidate based on the luma collocated block, collocated with the chroma block unit, to generate a first chroma prediction block. In addition, the decoder module 124 may predict chroma block unit based on a non-CCP prediction mode to generate a second prediction block. In some implementations, the non-CCP mode may be one of a Planar mode, a DC mode, a chroma directional mode, a DIMD mode, a DM mode, and a DBV mode. Then, the decoder module 124 may weightedly combine the first chroma prediction block and the second chroma prediction block by two weighting parameters to generate the chroma predicted block.

In yet some other implementations, the decoder module 124 may predict the chroma block unit using a first selected one of the CCP relocated candidates based on the luma collocated block, collocated with the chroma block unit, to generate the first chroma prediction block. In addition, the decoder module 124 may then predict the chroma block unit using a second selected one of the CCP relocated candidates based on the luma collocated block, collocated with the chroma block unit, to generate the second chroma prediction block. Then, the decoder module 124 may weightedly combine the first chroma prediction block and the second chroma prediction block by two weighting parameters to generate the chroma predicted block.

In some implementations, the two weighting parameters may be predefined in the first electronic device 110 and the second electronic device 120. For example, the two weighting parameters may be equal to (0.5, 0.5) or (⅔, ⅓). In some other implementations, the two weighting parameters may be derived based on multiple template cost values calculated based on neighboring chroma samples neighboring the chroma block unit and neighboring luma samples neighboring the luma collocated block by using the two prediction modes of the two chroma prediction blocks.

In some implementations, the bitstream may include a CCP relocated enable flag. The CCP relocated enable flag may be used to indicate whether the CCP relocated candidates in the CCP relocated list are enabled to reconstruct the chroma block unit. The CCP relocated enable flag may be signaled in a chroma syntax structure. In some implementations, the CCP relocated enable flag may be signaled at a high-level syntax structure (e.g., a video parameter set (VPS), a sequence parameter set (SPS), and a picture parameter set (PPS)). In some implementations, the CCP relocated enable flag may be signaled at a low-level syntax structure (e.g., a picture header, a slice header, a tile header, a CTU row header, a CTU-level flag, and a block-level flag).

The decoder module 124 may determine multiple chroma residual components of a chroma residual block from the bitstream for the chroma block unit and add the chroma residual components into the chroma predicted block to reconstruct the chroma block unit. The decoder module 124 may reconstruct all of the other chroma block units in the image frame for reconstructing the image frame and the video. The method/process 300 may then end.

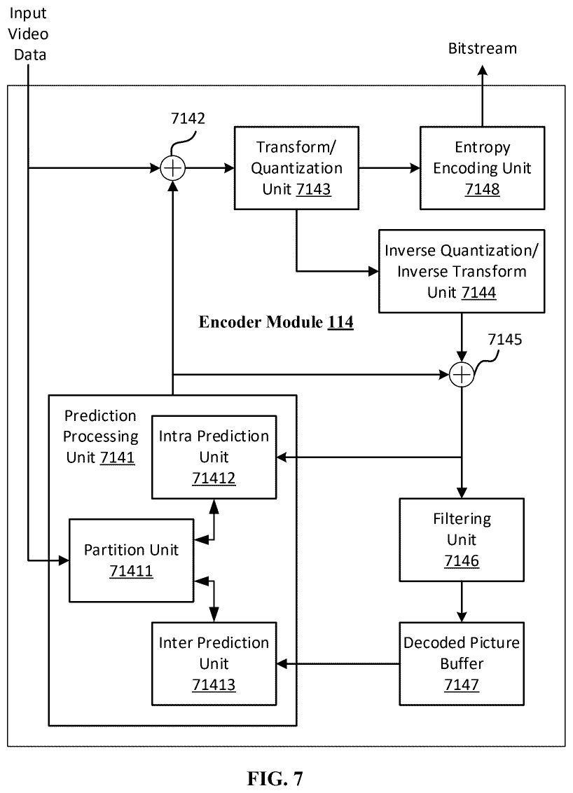

FIG. 7 is a block diagram illustrating an encoder module 114 of the first electronic device 110 illustrated in FIG. 1, in accordance with one or more example implementations of this disclosure. The encoder module 114 may include a prediction processor (e.g., a prediction processing unit 7141), at least a first summer (e.g., a first summer 7142) and a second summer (e.g., a second summer 7145), a transform/quantization processor (e.g., a transform/quantization unit 7143), an inverse quantization/inverse transform processor (e.g., an inverse quantization/inverse transform unit 7144), a filter (e.g., a filtering unit 7146), a decoded picture buffer (e.g., a decoded picture buffer 7147), and an entropy encoder (e.g., an entropy encoding unit 7148). The prediction processing unit 7141 of the encoder module 114 may further include a partition processor (e.g., a partition unit 71411), an intra prediction processor (e.g., an intra prediction unit 71412), and an inter prediction processor (e.g., an inter prediction unit 71413). The encoder module 114 may receive the source video and encode the source video to output a bitstream.

The encoder module 114 may receive source video including multiple image frames and then divide the image frames according to a coding structure. Each of the image frames may be divided into at least one image block.

The at least one image block may include a luminance block having multiple luminance samples and at least one chrominance block having multiple chrominance samples. The luminance block and the at least one chrominance block may be further divided to generate macroblocks, CTUs, CBs, sub-divisions thereof, and/or other equivalent coding units.

The encoder module 114 may perform additional sub-divisions of the source video. It should be noted that the disclosed implementations are generally applicable to video coding regardless of how the source video is partitioned prior to and/or during the encoding.

During the encoding process, the prediction processing unit 7141 may receive a current image block of a specific one of the image frames. The current image block may be the luminance block or one of the chrominance blocks in the specific image frame.

The partition unit 71411 may divide the current image block into multiple block units. The intra prediction unit 71412 may perform intra-predictive coding of a current block unit relative to one or more neighboring blocks in the same frame, as the current block unit, in order to provide spatial prediction. The inter prediction unit 71413 may perform inter-predictive coding of the current block unit relative to one or more blocks in one or more reference image blocks to provide temporal prediction.

The prediction processing unit 7141 may select one of the coding results generated by the intra prediction unit 71412 and the inter prediction unit 71413 based on a mode selection method, such as a cost function. The mode selection method may be a rate-distortion optimization (RDO) process.

The prediction processing unit 7141 may determine the selected coding result and provide a predicted block corresponding to the selected coding result to the first summer 7142 for generating a residual block and to the second summer 7145 for reconstructing the encoded block unit. The prediction processing unit 7141 may further provide syntax elements, such as motion vectors, intra-mode indicators, partition information, and/or other syntax information, to the entropy encoding unit 7148.

The intra prediction unit 71412 may intra-predict the current block unit. The intra prediction unit 71412 may determine an intra prediction mode directed toward a reconstructed sample neighboring the current block unit in order to encode the current block unit.

The intra prediction unit 71412 may encode the current block unit using various intra prediction modes. The intra prediction unit 71412 of the prediction processing unit 7141 may select an appropriate intra prediction mode from the selected modes. The intra prediction unit 71412 may encode the current block unit using a cross-component prediction mode to predict one of the two chroma components of the current block unit based on the luma components of the current block unit. The intra prediction unit 71412 may predict a first one of the two chroma components of the current block unit based on the second of the two chroma components of the current block unit.

The inter prediction unit 71413 may inter-predict the current block unit as an alternative to the intra prediction performed by the intra prediction unit 71412. The inter prediction unit 71413 may perform motion estimation to estimate motion of the current block unit for generating a motion vector.

The motion vector may indicate a displacement of the current block unit within the current image block relative to a reference block unit within a reference image block. The inter prediction unit 71413 may receive at least one reference image block stored in the decoded picture buffer 7147 and estimate the motion based on the received reference image blocks to generate the motion vector.

The first summer 7142 may generate the residual block by subtracting the prediction block determined by the prediction processing unit 7141 from the original current block unit. The first summer 7142 may represent the component or components that perform this subtraction.

The transform/quantization unit 7143 may apply a transform to the residual block in order to generate a residual transform coefficient and then quantize the residual transform coefficients to further reduce the bit rate. The transform may be one of a DCT, DST, AMT, MDNSST, HyGT, signal-dependent transform, KLT, wavelet transform, integer transform, sub-band transform, and a conceptually similar transform.

The transform may convert the residual information from a pixel value domain to a transform domain, such as a frequency domain. The degree of quantization may be modified by adjusting a quantization parameter.

The transform/quantization unit 7143 may perform a scan of the matrix including the quantized transform coefficients. Alternatively, the entropy encoding unit 7148 may perform the scan.

The entropy encoding unit 7148 may receive multiple syntax elements from the prediction processing unit 7141 and the transform/quantization unit 7143, including a quantization parameter, transform data, motion vectors, intra modes, partition information, and/or other syntax information. The entropy encoding unit 7148 may encode the syntax elements into the bitstream.

The entropy encoding unit 7148 may entropy encode the quantized transform coefficients by performing CAVLC, CABAC, SBAC, PIPE coding, or another entropy coding technique to generate an encoded bitstream. The encoded bitstream may be transmitted to another device (e.g., the second electronic device 120, as shown in FIG. 1) or archived for later transmission or retrieval.

The inverse quantization/inverse transform unit 7144 may apply inverse quantization and inverse transformation to reconstruct the residual block in the pixel domain for later use as a reference block. The second summer 7145 may add the reconstructed residual block to the prediction block provided by the prediction processing unit 7141 in order to produce a reconstructed block for storage in the decoded picture buffer 7147.

The filtering unit 7146 may include a deblocking filter, an SAO filter, a bilateral filter, and/or an ALF to remove blocking artifacts from the reconstructed block. Other filters (in loop or post loop) may be used in addition to the deblocking filter, the SAO filter, the bilateral filter, and the ALF. Such filters are not illustrated for brevity and may filter the output of the second summer 7145.

The decoded picture buffer 7147 may be a reference picture memory that stores the reference block to be used by the encoder module 714 to encode video, such as in intra-coding or inter-coding modes. The decoded picture buffer 7147 may include a variety of memory devices, such as DRAM (e.g., including SDRAM), MRAM, RRAM, or other types of memory devices. The decoded picture buffer 7147 may be on-chip with other components of the encoder module 114 or off-chip relative to those components.

The method/process 300 for decoding and/or encoding video data may be performed by the first electronic device 110. With reference to FIGS. 1 and 7, at block 310, the method/process 300 may start by the encoder module 114 receiving the video data. The video data received by the encoder module 114 may be a video.

At block 320, the encoder module 114 may determine a chroma block unit from an image frame of the video data.

With reference to FIGS. 1 and 7, the encoder module 114 may determine the image frames from the video. A current frame may be one of the image frames. The encoder module 114 may further divide the current frame to determine a block unit. In some implementations, the encoder module 114 may divide the current frame to generate multiple CTUs, and may further divide a current CTU, included in the CTUs, to generate multiple divided blocks and to determine the block unit from the divided blocks.

In some other implementations, the encoder module 114 may divide the current frame to generate multiple slices or multiple tiles, and further divide a current slice or a current tile, included in the slices or the tiles, to generate multiple CTUs. In addition, the encoder module 114 may further divide a current CTU, included in the CTUs, to generate multiple divided blocks and to determine the block unit from the divided blocks.

In some implementations, only one luma block unit may be collocated with the chroma block unit and regarded as a luma collocated block when the chroma block unit is included in a single-tree block unit that is determined from the current frame. In some other implementations, at least one luma block unit may be covered by the luma collocated block that is collocated with the chroma block unit when the chroma block unit is included in a dual-tree block unit. The dual-tree block unit may be determined from the current frame. Since the luma collocated block may be predicted prior to the prediction of the chroma block unit, a luma block vector may be determined for predicting and reconstructing a portion or all of the luma collocated block of the block unit prior to the prediction of the chroma block unit.

The size of the chroma block unit may be Wb×Hb. In some implementations, each of the Wb and Hb may be a positive integer (e.g., four, eight, etc.) that may be the same, or different from each other.

At block 330, the encoder module 114 may determine a guiding block vector of the chroma block unit.

With reference to FIGS. 1 and 7, the encoder module 114 may determine the guiding block vector based on one of a luma guiding vector and a chroma guiding vector. In some implementations, the luma guiding vector may be a luma reference vector of a luma reference unit covered by the luma collocated block. In some implementations, the chroma guiding vector may be a chroma reference vector of a chroma reference unit selected from multiple chroma adjacent units, multiple chroma non-adjacent units, and multiple chroma temporal units. In the implementations, the guiding block vector of the chroma block unit, determined by the encoder module 114, may be identical to the guiding block vector of the chroma block unit, determined by the decoder module 124.

Referring back to FIG. 3, at block 340, the encoder module 114 may determine a first chroma relocated block that is indicated by the guiding block vector, of the chroma block unit, that starts from the chroma block unit.

With reference to FIGS. 1 and 7, the encoder module 114 may determine the first chroma relocated block that is indicated by the guiding block vector, of the chroma block unit, that starts from one of multiple guiding start positions of the chroma block unit to one of multiple guiding end positions for determining the first chroma relocated block. In the implementations, the guiding start positions of the chroma block unit, determined by the encoder module 114, may be identical to the guiding start positions of the chroma block unit, determined by the decoder module 124. In addition, the guiding end positions of the chroma block unit, determined by the encoder module 114, may be identical to the guiding end positions of the chroma block unit, determined by the decoder module 124.

In some implementations, a search order of the guiding start positions for determining the first chroma relocated block may be predefined in the first electronic device 110 and the second electronic device 120. Thus, the search order of the guiding start positions, performed by the encoder module 114, may be identical to the search order of the guiding start positions, performed by the decoder module 124.

In some implementations, a method for determining the spatial relationship between the guiding end position and the first chroma relocated block may be predefined in the first electronic device 110 and the second electronic device 120. Thus, the method for determining the spatial relationship between the guiding end position and the first chroma relocated block, performed by the encoder module 114, may be identical to the method for determining the spatial relationship between the guiding end position and the first chroma relocated block, performed by the decoder module 124.

Referring back to FIG. 3, at block 350, the encoder module 114 may determine a first relocated cross-component prediction (CCP) filter based on a first relocated position of the first chroma relocated block.

With reference to FIGS. 1 and 7, the encoder module 114 may determine at least one chroma relocated unit, each associated with the first chroma relocated block. Each of the at least one chroma relocated unit may be partly or fully covered by the first chroma relocated block. The encoder module 114 may determine multiple chroma relocated positions in the first chroma relocated block. In some implementations, a search order of the chroma relocated positions for determining a relocated CCP filter may be predefined in the first electronic device 110 and the second electronic device 120. Thus, the search order of the chroma relocated positions, performed by the encoder module 114, may be identical to the search order of the chroma relocated positions, performed by the decoder module 124.

When a first one of the at least one chroma relocated unit, which covers a first relocated position of the chroma relocated positions in the first chroma relocated block, is predicted and reconstructed by using the CCP prediction mode, the first chroma relocated unit may be predicted and reconstructed by using a first relocated CCP filter. Thus, the first relocated CCP filter may be determined based on the first relocated position of the first chroma relocated block. In addition, a second relocated CCP filter may be determined based on a second relocated position of the chroma relocated positions in the first chroma relocated block. The first relocated CCP filter of the first chroma relocated unit and the second relocated CCP filter of the second chroma relocated unit may be used to predict the chroma block unit.

When a third one of the at least one chroma relocated unit, which covers a third relocated position of the chroma relocated positions in the first chroma relocated block, is predicted and reconstructed by using a block vector prediction mode, the third chroma relocated unit may be predicted and reconstructed by using a first relocated block vector. Thus, the first relocated block vector may be determined based on the third relocated position of the first chroma relocated block. The first relocated block vector may be used to determine a second chroma relocated block that is indicated by the first relocated block vector that starts from the first chroma relocated block. In some implementations, the block vector prediction mode may include the IBC mode, the intraTMP mode, and the DBV mode. The first to the third chroma relocated units may be different from each other. In addition, the first to the third chroma relocated positions may also be different from each other.

The encoder module 114 may determine an (N−1)-th relocated block vector based on a relocated position of an (N−1)-th chroma relocated block. In addition, the encoder module 114 may determine an N-th chroma relocated block that is indicated by the (N−1)-th relocated block vector, of a chroma relocated unit of the (N−1)-th chroma relocated block, that starts from a (N−1)-th relocated start position in the (N−1)-th chroma relocated block to another (N−1)-th relocated end position. The method for determining the (N−1)-th relocated start position in the (N−1)-th chroma relocated block may be predefined in the first electronic device 110 and the second electronic device 120. In the implementations, the (N−1)-th relocated start position in the (N−1)-th chroma relocated block, determined by the encoder module 114, may be identical to the (N−1)-th relocated start position in the (N−1)-th chroma relocated block, determined by the decoder module 124. In addition, the (N−1)-th relocated end position, determined by the encoder module 114, may be identical to the (N−1)-th relocated end position, determined by the decoder module 124. In some implementations, the number N may be a relocated level of the N-th chroma relocated block. In some implementations, the number N may be a positive integer, equal to, or greater than, two.

The (N−1)-th relocated end position of the (N−1)-th relocated block vector may be first determined based on the (N−1)-th relocated block vector and the (N−1)-th relocated start position of the (N−1)-th relocated block vector. Then, the N-th chroma relocated block may be determined by uniformly extending a block from the (N−1)-th relocated end position in all directions to generate an intermediate block that has the same size, as the chroma block unit. The intermediate block, covering the (N−1)-th relocated end position, which is located at a center position of the intermediate block, can be regarded as the N-th chroma relocated block. In the implementations, the N-th chroma relocated block, determined by the encoder module 114, may be identical to the N-th chroma relocated block, determined by the decoder module 124.

The encoder module 114 may determine a K-th relocated CCP filter based on the at least one chroma relocated unit, associated with the N-th chroma relocated block. In the implementations, the K-th relocated CCP filter, determined by the encoder module 114, may be identical to the K-th relocated CCP filter, determined by the decoder module 124. In some implementations, the number K may be an integer, equal to, or greater than one. In some implementations, the number K may be equal to, or different from, the number N.

In some implementations, the encoder module 114 may keep determining whether the at least one chroma relocated unit is reconstructed by using the block vector prediction mode when the relocated level of the N-th chroma relocated block equal to N is less than a relocated level threshold. In some other implementations, the encoder module 114 may stop determining whether the at least one chroma relocated unit is reconstructed by using the block vector prediction mode when the relocated level of the N-th chroma relocated block equal to N is equal to the relocated level threshold. In some implementations, the relocated level threshold may be predefined in the first electronic device 110 and the second electronic device 120. In some implementations, the relocated level threshold may be equal to two, three, or four.

Referring back to FIG. 3, at block 360, the encoder module 114 may determine the first relocated CCP filter as one of a plurality of CCP relocated candidates in a CPP relocated list of the chroma block unit. With reference to FIGS. 1 and 7, the CPP relocated list, determined by the encoder module 114, may be identical to the CPP relocated list, determined by the decoder module 124.

The number of the CCP relocated candidates in the CCP relocated list may be equal to, or less than, a relocated quantity threshold. In some implementations, the relocated quantity threshold may be predefined in the first electronic device 110 and the second electronic device 120. In some implementations, the relocated quantity threshold may be equal to twenty.

In some implementations, the CCP relocated candidates in the CCP relocated list may be added in a CCP merge list. In other words, the CCP relocated list may be partly or fully included in the CCP merge list. The CCP merge list of the chroma block unit for predicting and/or reconstructing the chroma block unit may include multiple CCP merge candidates. In some implementations, the relocated quantity threshold may be equal to, or less than, a CCP merge quantity threshold of the CCP merge list. In some implementations, at least one of the CCP relocated candidates may be included in the CCP merge candidates of the CCP merge list of the chroma block unit. In some other implementations, the relocated quantity threshold may be less than an intra merge quantity threshold of an intra merge list.

In some other implementations, the CCP relocated candidates may be added in the CCP relocated list, but not be added in the CCP merge list. In other words, the CCP relocated list may be separated from the CCP merge list.

The CCP merge list may include at least one of multiple CCP adjacent candidates, multiple CCP non-adjacent candidates, multiple CCP temporal candidates, and multiple CCP history-based candidates. In addition, the CPP merge list, determined by the encoder module 114, may be identical to the CPP merge list, determined by the decoder module 124. In some implementations, the CCP relocated candidates may be derived when the derivation of the CCP adjacent candidates, and the CCP non-adjacent candidates, the CCP temporal candidates, the CCP history-based candidate has ended. In some other implementations, multiple CCP relocated adjacent candidates may be derived immediately after the derivation of the CCP adjacent candidates has completed. In addition, multiple CCP relocated non-adjacent candidates may be derived immediately after the derivation of the CCP non-adjacent candidates has completed. Multiple CCP relocated temporal candidates may be derived immediately after the derivation of the CCP temporal candidates has completed.

In some implementations, the encoder module 114 may keep determining whether the at least one chroma relocated unit is reconstructed by using the CCP prediction mode when the number of the added CCP relocated candidates in the CCP relocated list is still less than the relocated quantity threshold. In some other implementations, the encoder module 114 may stop determining whether the at least one chroma relocated unit is reconstructed by using the CCP prediction mode when the number of the added CCP relocated candidates in the CCP relocated list has been equal to the relocated quantity threshold.

Referring back to FIG. 3, at block 370, the encoder module 114 may reconstruct the chroma block unit based on the CCP relocated list of the chroma block unit.

With reference to FIGS. 1 and 7, in some implementations, the encoder module 114 may determine a chroma candidate list of the chroma block unit for predicting and/or reconstructing the chroma block unit.

The chroma candidate list may include multiple chroma prediction candidates, selected from at least one of the CCP relocated candidates, or other chroma prediction candidate. In some implementations, the encoder module 114 may predict the chroma block unit based on each of the chroma prediction candidates, including the CCP relocated candidates, to generate multiple chroma predicted blocks.

In some other implementations, the encoder module 114 may predict the chroma block unit based on each of the chroma prediction candidates, including the CCP relocated candidates, to generate multiple first chroma prediction blocks. In addition, the encoder module 114 may predict the chroma block unit based on each of the chroma prediction candidates to generate multiple second chroma prediction blocks. Then, the encoder module 114 may select one of the first chroma prediction blocks and one of the second chroma prediction blocks and weightedly combine them by two weighting parameters to generate the chroma predicted block. In the implementations, the selected first chroma prediction block may be different from the selected second chroma prediction block.

The encoder module 114 may select one of the chroma predicted blocks based on a mode selection method, such as a cost function. The mode selection method may be an RDO process, a Sum of Absolute Difference (SAD) process, a Sum of Absolute Transformed Difference (SATD) process, a Mean Absolute Difference (MAD) process, a Mean Squared Difference (MSD) process, or a Structural SIMilarity (SSIM) process. The encoder module 114 may provide the selected coding result to the first summer 7142 for generating a chroma residual block and to the second summer 7145 for reconstructing the encoded chroma block unit.

The encoder module 114 may further encode syntax elements into a bitstream, for transmitting to the decoder module 124. The syntax elements of the chroma block unit may be used to determine a selected chroma prediction candidate corresponding to the selected chroma predicted block. The syntax elements of the chroma block unit may include at least one of a chroma prediction index, a CCP merge index, and a CCP relocated index. The chroma prediction index may be used to select the chroma prediction mode from the chroma prediction candidates. The CCP merge index may be used to select the chroma prediction mode from the CCP merge candidates. The CCP relocated index may be used to select the chroma prediction mode from the CCP relocated candidates.

In some implementations, the syntax elements, associated with the chroma block unit, may further include a CCP relocated enable flag. The CCP relocated enable flag may be used to indicate whether the CCP relocated candidates in the CCP relocated list are enabled to reconstruct the chroma block unit. The CCP relocated enable flag may be signaled in a chroma syntax structure. In some implementations, the CCP relocated enable flag may be signaled at a high-level syntax structure (e.g., a video parameter set (VPS), a sequence parameter set (SPS), and a picture parameter set (PPS)). In some implementations, the CCP relocated enable flag may be signaled at a low-level syntax structure (e.g., a picture header, a slice header, a tile header, a CTU row header, a CTU-level flag, and a block-level flag).

In some implementations, the syntax elements, associated with the chroma block unit, may further include a CCP relocated mode flag. The CCP relocated mode flag may be used to indicate whether the CCP relocated candidates in the CCP relocated list are included in the CCP merge list. The CCP relocated mode flag may be signaled in a chroma syntax structure.

In some implementations, the syntax elements, associated with the chroma block unit, may further include multiple partition indications generated according to the partitioning of the chroma block unit (e.g., based on any video coding standard).

When a specific one of the CCP relocated candidates is selected, the encoder module 114 may predict the chroma block unit based on the selected CCP relocated candidate, to generate the chroma predicted block. The encoder module 114 may determine multiple chroma residual components of a chroma residual block for the chroma block unit based on the chroma predicted block. In addition, the encoder module 114 may add the chroma residual components back into the chroma predicted block to reconstruct the chroma block unit.

The reconstruction of the chroma block unit by the encoder module 114 may be identical to the reconstruction of the chroma block unit by the decoder module 124. The method/process 300 for the encoder module 114 may then end.

The disclosed implementations are to be considered in all respects as illustrative and not restrictive. It should also be understood that the present disclosure is not limited to the specific disclosed implementations, but that many rearrangements, modifications, and substitutions are possible without departing from the scope of the present disclosure.

What is claimed is:

1. A non-transitory machine-readable medium of an electronic device storing one or more computer-executable instructions for decoding video data, the one or more computer-executable instructions, when executed by at least one processor of the electronic device, causing the electronic device to:
receive the video data;
determine a chroma block unit from an image frame of the video data;
determine a guiding block vector of the chroma block unit;
determine a first chroma relocated block that is indicated by the guiding block vector, of the chroma block unit, that starts from the chroma block unit;
determine a first relocated cross-component prediction (CCP) filter based on a first relocated position of the first chroma relocated block, wherein the first relocated CCP filter is one of a plurality of CCP relocated candidates in a CPP relocated list of the chroma block unit; and
reconstruct the chroma block unit based on the CCP relocated list of the chroma block unit.

2. The non-transitory machine-readable medium of claim 1, wherein the one or more computer-executable instructions, when executed by at least one processor of the electronic device, further cause the electronic device to:
determine at least one chroma relocated prediction mode of at least one chroma relocated unit, wherein:
each of the at least one chroma relocated unit is associated with the first chroma relocated block, and
a first one of the at least one chroma relocated unit is reconstructed by using the first relocated CCP filter when the first one of the at least one chroma relocated unit is reconstructed by using a CCP prediction mode and covers the first relocated position of the first chroma relocated block.

3. The non-transitory machine-readable medium of claim 2, wherein the one or more computer-executable instructions, when executed by at least one processor of the electronic device, further cause the electronic device to:
determine a second relocated CCP filter based on a second relocated position of the first chroma relocated block, wherein
a second one of the at least one chroma relocated unit is reconstructed by using the second relocated CCP filter when the second one of the at least one chroma relocated unit is reconstructed by using the CCP prediction mode and covers the second relocated position of the first chroma relocated block; and
determine the second relocated CCP filter as one of the plurality of CCP relocated candidates in the CPP relocated list of the chroma block unit.

4. The non-transitory machine-readable medium of claim 1, wherein the one or more computer-executable instructions, when executed by at least one processor of the electronic device, further cause the electronic device to:
determine a first relocated block vector based on a second relocated position of the first chroma relocated block;
determine a second chroma relocated block that is indicated by the first relocated block vector that starts from the first chroma relocated block; and
determine a second relocated CCP filter based on a first relocated position of the second chroma relocated block, wherein the second relocated CCP filter is one of the plurality of CCP relocated candidates in the CPP relocated list of the chroma block unit.

5. The non-transitory machine-readable medium of claim 4, wherein the one or more computer-executable instructions, when executed by at least one processor of the electronic device, further cause the electronic device to:
determine at least one chroma relocated prediction mode of at least one chroma relocated unit, wherein:
each of the at least one chroma relocated unit is associated with the first chroma relocated block, and
a first one of the at least one chroma relocated unit is reconstructed by using the first relocated block vector when the first one of the at least one chroma relocated unit is reconstructed by using a block vector prediction mode and covers the second relocated position of the first chroma relocated block.

6. The non-transitory machine-readable medium of claim 4, wherein determining the second chroma relocated block that is indicated by the first relocated block vector that starts from the first chroma relocated block further comprises:
determining a center position of the second chroma relocated block that is indicated by the first relocated block vector that starts from the second relocated position of the first chroma relocated block; and
determining the second chroma relocated block based on the center position of the second chroma relocated block and a size of the chroma block unit.

7. The non-transitory machine-readable medium of claim 1, wherein the one or more computer-executable instructions, when executed by at least one processor of the electronic device, further cause the electronic device to:
determine an (N−1)-th relocated block vector based on a relocated position of an (N−1)-th chroma relocated block;
determine an N-th chroma relocated block that is indicated by the (N−1)-th relocated block vector that starts from the (N−1)-th chroma relocated block, wherein the number N is a relocated level of the N-th chroma relocated block;
determine at least one chroma relocated prediction mode of at least one chroma relocated unit, wherein each of the at least one chroma relocated unit is associated with the N-th chroma relocated block; and
forgo determining whether the at least one chroma relocated unit is reconstructed by using a block vector prediction mode when the relocated level of the N-th chroma relocated block equal to N is equal to a relocated level threshold.

8. The non-transitory machine-readable medium of claim 1, wherein at least one of the plurality of CCP relocated candidates is included in a CCP merge list of the chroma block unit.

9. An electronic device for decoding video data, the electronic device comprising:
at least one processor; and
one or more non-transitory computer-readable media coupled to the at least one processor and storing one or more computer-executable instructions that, when executed by the at least one processor, cause the electronic device to:
receive the video data;
determine a chroma block unit from an image frame of the video data;
determine a guiding block vector of the chroma block unit;
determine a first chroma relocated block that is indicated by the guiding block vector, of the chroma block unit, that starts from the chroma block unit;
determine a first relocated cross-component prediction (CCP) filter based on a first relocated position of the first chroma relocated block, wherein the first relocated CCP filter is one of a plurality of CCP relocated candidates in a CPP relocated list of the chroma block unit; and
reconstruct the chroma block unit based on the CCP relocated list of the chroma block unit.

10. The electronic device of claim 9, wherein the one or more computer-executable instructions, when executed by at least one processor of the electronic device, further cause the electronic device to:
determine at least one chroma relocated prediction mode of at least one chroma relocated unit, wherein:
each of the at least one chroma relocated unit is associated with the first chroma relocated block, and
a first one of the at least one chroma relocated unit is reconstructed by using the first relocated CCP filter when the first one of the at least one chroma relocated unit is reconstructed by using a CCP prediction mode and covers the first relocated position of the first chroma relocated block.

11. The electronic device of claim 9, wherein the one or more computer-executable instructions, when executed by at least one processor of the electronic device, further cause the electronic device to:
determine a first relocated block vector based on a second relocated position of the first chroma relocated block;
determine a second chroma relocated block that is indicated by the first relocated block vector that starts from the first chroma relocated block; and
determine a second relocated CCP filter based on a first relocated position of the second chroma relocated block, wherein the second relocated CCP filter is one of the plurality of CCP relocated candidates in the CPP relocated list of the chroma block unit.

12. The electronic device of claim 9, wherein the one or more computer-executable instructions, when executed by at least one processor of the electronic device, further cause the electronic device to:
determine an (N−1)-th relocated block vector based on a relocated position of an (N−1)-th chroma relocated block;
determine an N-th chroma relocated block that is indicated by the (N−1)-th relocated block vector that starts from the (N−1)-th chroma relocated block, wherein the number N is a relocated level of the N-th chroma relocated block;
determine at least one chroma relocated prediction mode of at least one chroma relocated unit, wherein each of the at least one chroma relocated unit is associated with the N-th chroma relocated block; and
forgo determining whether the at least one chroma relocated unit is reconstructed by using a block vector prediction mode when the relocated level of the N-th chroma relocated block equal to N is equal to a relocated level threshold.

13. An electronic device for encoding video data, the electronic device comprising:
at least one processor; and
one or more non-transitory computer-readable media coupled to the at least one processor and storing one or more computer-executable instructions that, when executed by the at least one processor, cause the electronic device to:
receive the video data;
determine a chroma block unit from an image frame of the video data;
determine a guiding block vector of the chroma block unit;
determine a first chroma relocated block that is indicated by the guiding block vector, of the chroma block unit, that starts from the chroma block unit;
determine a first relocated cross-component prediction (CCP) filter based on a first relocated position of the first chroma relocated block, wherein the first relocated CCP filter is one of a plurality of CCP relocated candidates in a CPP relocated list of the chroma block unit; and
reconstruct the chroma block unit based on the CCP relocated list of the chroma block unit.

14. The electronic device of claim 13, wherein the one or more computer-executable instructions, when executed by at least one processor of the electronic device, further cause the electronic device to:
determine at least one chroma relocated prediction mode of at least one chroma relocated unit, wherein:
each of the at least one chroma relocated unit is associated with the first chroma relocated block, and
a first one of the at least one chroma relocated unit is reconstructed by using the first relocated CCP filter when the first one of the at least one chroma relocated unit is reconstructed by using a CCP prediction mode and covers the first relocated position of the first chroma relocated block.

15. The electronic device of claim 14, wherein the one or more computer-executable instructions, when executed by at least one processor of the electronic device, further cause the electronic device to:
determine a second relocated CCP filter based on a second relocated position of the first chroma relocated block, wherein
a second one of the at least one chroma relocated unit is reconstructed by using the second relocated CCP filter when the second one of the at least one chroma relocated unit is reconstructed by using the CCP prediction mode and covers the second relocated position of the first chroma relocated block; and
determine the second relocated CCP filter as one of the plurality of CCP relocated candidates in the CPP relocated list of the chroma block unit.

16. The electronic device of claim 13, wherein the one or more computer-executable instructions, when executed by at least one processor of the electronic device, further cause the electronic device to:
determine a first relocated block vector based on a second relocated position of the first chroma relocated block;
determine a second chroma relocated block that is indicated by the first relocated block vector that starts from the first chroma relocated block; and
determine a second relocated CCP filter based on a first relocated position of the second chroma relocated block, wherein the second relocated CCP filter is one of the plurality of CCP relocated candidates in the CPP relocated list of the chroma block unit.

17. The electronic device of claim 16, wherein the one or more computer-executable instructions, when executed by at least one processor of the electronic device, further cause the electronic device to:
determine at least one chroma relocated prediction mode of at least one chroma relocated unit, wherein:
each of the at least one chroma relocated unit is associated with the first chroma relocated block, and
a first one of the at least one chroma relocated unit is reconstructed by using the first relocated block vector when the first one of the at least one chroma relocated unit is reconstructed by using a block vector prediction mode and covers the second relocated position of the first chroma relocated block.

18. The electronic device of claim 16, wherein the one or more computer-executable instructions, when executed by at least one processor of the electronic device, further cause the electronic device to:
determining a center position of the second chroma relocated block that is indicated by the first relocated block vector that starts from the second relocated position of the first chroma relocated block; and
determining the second chroma relocated block based on the center position of the second chroma relocated block and a size of the chroma block unit.

19. The electronic device of claim 13, wherein the one or more computer-executable instructions, when executed by at least one processor of the electronic device, further cause the electronic device to:
determine an (N−1)-th relocated block vector based on a relocated position of an (N−1)-th chroma relocated block;
determine an N-th chroma relocated block that is indicated by the (N−1)-th relocated block vector that starts from the (N−1)-th chroma relocated block, wherein the number N is a relocated level of the N-th chroma relocated block;
determine at least one chroma relocated prediction mode of at least one chroma relocated unit, wherein each of the at least one chroma relocated unit is associated with the N-th chroma relocated block; and
forgo determining whether the at least one chroma relocated unit is reconstructed by using a block vector prediction mode when the relocated level of the N-th chroma relocated block equal to N is equal to a relocated level threshold.

20. The electronic device of claim 13, wherein at least one of the plurality of CCP relocated candidates is included in a CCP merge list of the chroma block unit.
